(19) United States
(12) Patent Application Publication
(10) Pub. No.: US 2024/0095718 A1
(43) Pub. Date: Mar. 21, 2024

(54) CUSTOMIZED RETAIL ENVIRONMENTS

(71) Applicant: Amazon Technologies, Inc., Seattle, WA (US)

(72) Inventors: Aaron M. McDaniel, Seattle, WA (US); Robert Jerome Colwill, Bainbridge Island, WA (US); Nirmal Doshi, Bothell, WA (US); Andrew Michael Smith, Burien, WA (US); David Zhang, Bothell, WA (US)

(21) Appl. No.: 17/948,989

(22) Filed: Sep. 20, 2022

(51) Int. Cl. G06Q 20/36; G06Q 30/06; G06V 20/52

(52) U.S. Cl. CPC G06Q 20/363; G06Q 30/0635; G06V 20/52

(57) ABSTRACT

This disclosure describes, in part, systems for enabling facilities to implement techniques to determine when users are in possession of items when located within and/or exiting the facilities. For instance, a system may use one or more sensors to determine locations of a user that navigated through a facility. Additionally, the system may use one or more sensors to determine locations of an item while the item was located within the facility. The system may then determine a probability that the user was in possession of the item when in the facility and/or when exiting the facility based at least in part on the locations of the user and the locations of the item. If the system determines that the user was in possession of the item when exiting the facility, the system may charge a payment instrument of the user for a price of the item.

### BACKGROUND

Traditional physical stores maintain an inventory of items in customer-accessible areas such that customers can pick items from the inventory and take them to a cashier for purchase, rental, and so forth. For example, a customer may take an item, such as a shirt, from a rack located within the store. The customer may then take the shirt to a cashier that is located near an entrance of the store. Using a point-of-sale device, the cashier may process a transaction for a price of the shirt. For example, the cashier may input payment information, such as a card number, into the point-of-sale device, which may charge the card of the customer for the price of the shirt.

### BRIEF DESCRIPTION OF FIGURES

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example facility associated with a system for enabling automated checkout (AC) techniques to allow users to enter the facility, remove items that are located at inventory locations within the facility, and exit the facility without performing a manual checkout of the items, according to at least one example.

FIG. 2 illustrates an example of the system determining that the user was in possession of the item using directions of movement of the user and the item, according to at least one example.

FIG. 3 illustrates an example of the system determining that the user was in possession of the item using timed entries into sensor regions, according to at least one example.

FIGS. 4A-4B illustrate examples of the type of information that may be included in timestamps for an item, according to at least some examples.

FIG. 5 illustrates an example of a system disambiguating between users collecting items within the facility using movement directions through the facility, according to at least one example.

FIG. 6 illustrates an example of a system disambiguating between users collecting items within the facility using timed entries and exits through sensor regions, according to at least one example.

FIG. 7 illustrates an example of a sensor region including RFID sensors for detecting items, according to at least one example.

FIG. 8 illustrates an example of a sensor region including RFID sensors for detecting items at an exit of the facility, according to at least one example.

FIG. 9 illustrates an exit gate of the facility with cameras to disambiguate between zones at the exit gate, according to at least one example.

FIG. 10 illustrates an exit gate of the facility with presence sensors to disambiguate between zones at the exit gate, according to at least one example.

FIG. 11 illustrates an exit gate of the facility with RFID antennas directed to define zones at the exit gate for detecting items, according to at least one example.

FIG. 12 is an example process for using locations of a user and locations of an item to determine that the user was in possession of the item when exiting a facility, according to at least one example.

FIG. 13 is an example process for determining whether a user was in possession of an item, according to at least one example.

FIG. 14 is a block diagram of an example materials handling facility that includes sensors and an inventory management system configured to generate output regarding events occurring in the facility using the sensor data, according to at least one example.

FIG. 15 illustrates a block diagram of one or more servers configured to support operation of the facility, according to at least one example.

### DETAILED DESCRIPTION

This disclosure describes, in part, systems for enabling facilities (e.g., physical retail stores) to implement technology that is able to automatically determine items that users possess when exiting facilities. By using this technology, the users are able to pick items from inventory locations (e.g., shelves, racks, cases, cabinets, bins, floor locations, etc.) and exit the facilities without performing manual checkout. For instance, a system may use sensors located within a facility, such as cameras, to determine locations of a user as (and/or after) the user navigates throughout the facility. The system may further use sensors located within the facility, such as signal receivers, to determine locations of an item throughout the facility. The system may then use the locations of the user as well as the locations of the item to determine that the user was in possession of the item while within the facility and/or while exiting the facility. As such, the system may associate an identifier of the item with an account of the user. Additionally, the system may use payment information, which may be stored in association with the account, to automatically process a transaction for the price of the item (e.g., process the transaction without manual checkout).

This disclosure, in more detail, relates to the use of a system to track unique items using unique item identifiers (such as a radio frequency identification (RFID) tag) and thereby enable an automated checkout process for non-standardized items such as items sold by weight, customizable items, apparel, or other such items. The combined use of the first sensors, e.g., cameras, and the second sensors, e.g., RFID sensors, enables an automated checkout (AC) procedure for customizable items, apparel items, support expiration markdowns of items, additional layers of security for high value goods, and enhance inventory management. RFID technology includes non-contact non-line of site use of radio frequency waves to transfer data. The benefit of RFID sensor versus image-based sensors alone or image sensors and weight sensors combined is that RFID tags can provide individual item specific info in each item electronic product code (EPC) number. This may include expiration date, shirt size, specific variable weight price, etc. RFID tags and antennas can also read items that are either hidden from camera view or hard to see (stacked objects, motion blur, similar looking objects). In addition, RFID tags may be used to identify items that vision AI has a hard time to identify (i.e. deformable goods such as apparel). Accordingly, the RFID tags enable the use of AC systems with individualized items based on the use of RFID tags having item data associated therewith describing a price, characteristic, weight, or other such features of the item.

Further still, the RFID tags in combination with the cameras or other visions systems may be used to differentiate and disambiguate between users within a facility. For example, multiple users may be in close proximity to one another and to an inventory location where an item is retrieved. By tracking the locations and routes taken by the individuals within the facility as well as identifying the RFID tags as the users pass through set RFID sensor zones, the items may be uniquely identified to be associated with a particular user, thereby increasing a confidence that the user is the one who selected the item from the inventory location. For example, by associating an item to a customer as they pass through RFID read zones throughout a facility, this disclosure enables a solution for item tracking and item association with users that is fixture agnostic and unaffected by merchandising density.

The RFID tags used in association with the vision systems of the facility may be used for identifying apparel items selected by users. Apparel are typically merchandised on hangers, or even piled up on tables or boxes for sale. Customers may fold/unfold apparels and rummage for sizes, colors or designs. Such environments may be difficult for vision systems alone to distinguish what items are selected by users from such environments that can easily become ‘untidy.’ The RFID tags associated with, such as attached to a sales tag of the item, can be used to identify the items selected by the user and/or to increase a probability or confidence that the item identified is the item selected by the user. Additionally, RFID tags can also help identify unique characteristics (size, different qualities, patterns etc.), and be used for customer association at RFID sensor zones. RFID tags for apparels are common in the industry and can be applied upstream at supplier or in the store.

Further, RFID tags can be used to assist with expiration markdown for perishable items. If an item does not have a RFID tag, a RFID tag can be applied with the markdown information specific to that item. If an item already has the RFID tag, the RFID tag Electronic Product Code (EPC) information can be updated with a handheld device with barcode scanner and RFID encoder. In some examples, an associate can also apply a discount sticker to inform the customer of the markdown. Such systems enables some products in the same lanes to be full value, and some products at discounts based on their expiry dates, which would otherwise be difficult or impossible to distinguish using conventional AC systems. In some examples, RFID tags can be encoded with expiration dates. This can be used to help to track the item in a database, and later a handheld reader can quickly identify in a shelf, items that are expired for removal or close to expiry for discounts, without reading each label individually.

The combined RFID and vision systems within the facility can add a layer of security and help reduce shrink. For example, the RFID tags enable ready identification of items not visible to a vision sensor that may be carried within a tote, cart, or on the person of the user. Such items can be accounted for and charged to the account of the user upon exiting the facility.

In some examples, products requiring age verification is typically merchandised in a restricted area with an associate at the restricted area for ID check. RFID tagging of alcohol bottles or other age restricted items can enable it to be merchandised anywhere in the store and RFID scanners can identify when customers are exiting or approaching an exit with such items to enable a store associate to do an age verification check at exit.

Turning to a particular example, the user may enter the facility through an entry location, navigate through the facility looking for items, pick up an item (e.g., a shirt) from an inventory location within the facility, and exit the facility through an exit location. While in the facility, and at the knowledge and request/consent of the user, the system may use sensors (referred to, in these examples, as “first sensors”) to determine locations of the user while traveling through the facility. For example, the system may use cameras, floor weight sensors, and/or the like to generate sensor data (referred to, in these examples, as “first sensor data”). The system may then analyze this first sensor data (e.g., image data) to locate the user as (and/or after) the user navigates through the facility. The system may then store, in association with the account of the user, timestamp data (referred to, in these examples, as “first timestamp data”) representing at least times that the user was located at various locations within the facility.

Additionally, while the item is within the facility, the system may use sensors (referred to, in these examples, as “second sensors”) to determine locations of the item within the facility. For example, the item may include an attached device, such as a tag (e.g., a radio-frequency identification (RFID) tag), that transmits signals. In some instances, the device transmits the signals at a given frequency. Additionally, or alternatively, in some instances, the device transmits the signals after receiving signals from the second sensors. In either of the instances, the facility may use the second sensors, such as RFID readers, to receive the signals from the device attached to the item. The system may then analyze sensor data (referred to, in these examples, as “second sensor data”) to determine the locations of the item throughout the facility. For example, the RFID readers may be set up in particular RFID zones throughout the facility, the RFID zones limited to particular regions where traffic passes through the facility. In this manner, the RFID zones may be limited and thereby reduce interference and ‘noise’ from sensors and antennas throughout the store. Additionally, the system may store timestamp data (referred to, in these examples, as “second timestamp data”) representing at least times that the item was located at various locations within the facility, such as at the RFID zones.

The system may then use the first timestamp data and the second timestamp data to determine whether the user was in possession of the item when exiting the facility. For example, the system may use the first timestamp data and the second timestamp data to identify one or more times that the item was located proximate to the user within the facility and one or more times that the item was not located proximate to the user within the facility. For example, tracking the user to identify that the user is in a first RFID zone while the item is also present in the zone as determined by the RFID sensors. In this manner, as the user moves through the facility, and through one or more RFID zones, the confidence level that the item is associated with the user increases based on additional instances of detecting the presence of the item and the location of the user being within the same RFID zone at the same time.

The RFID zones may be established within the facility such that a path for a user will pass through at least one RFID zone as the user traverses the facility from the entrance to the exit. For example, placing the RFID zones at the ends of aisles, or intersections of aisles so that users will pass through the intersections. In some examples, multiple RFID zones are placed in locations throughout the facility, and a user may traverse at least some or all of the RFID zones to reach an exit location.

The RFID zones may be defined by the presence of one or more RFID sensors that may include one or more antennas and one or more RFID readers communicably coupled to the antennas. The antennas may be positioned at varying heights that correspond to expected heights at which items will be held or placed while traversing the RFID zones. For example, an RFID sensor may include two antennas, with a first antenna located in a range of three to twelve inches off the ground and configured to detect items placed in a tote held by an extended arm of a user. A second antenna may be located at a height of fourteen to forty inches off the ground and may be configured to detect items placed in a cart or held in the hands of a user. The antennas may be coupled to the RFID reader that is in communication with a system of the facility to determine the item identity and item information based on the RFID information read by the RFID reader.

In some examples the RFID zones may be placed throughout a facility including at or near an exit of the facility. The exit of the facility may be preceded by a series of gates for users to pass through. c

In some instances, the system may determine that the item was located proximate to the user when the item was located within a threshold distance (e.g., one meter, two meters, five meters, etc.) to the user and determine that the item was not located proximate to the user when the item was located outside of the threshold distance to the user. Additionally, or alternatively, in some instances, the system may determine that the item was located proximate to the user when the both the item and the user were located within a same area of the facility (e.g., a clothing isle, a shoe isle, at the exit location, etc.), and determine that the item was not located proximate to the user when the item was not located with the same area as the user.

The system may therefore differentiate between users who interact with an inventory location at or near the same time. In such examples, the vision sensors may not be able to determine a probability exceeding a threshold level that the first user is the one who selected a particular item. By tracking the locations of the users through the store, and identifying items as they pass through the various RFID zones, the items may be disambiguated to determine which of the users to associate the item. In some examples, the system may differentiate between items and users based on vision tracking of users relative to RFID read zones. For example, a vision tracking system may identify users that are closer or more remote from a read zone and thereby differentiate between the users and items held by each based on the signal strength of the RFID signals. A return signal strength indicator may be used to identify RFID items located near or remote from a center of a read zone or from a read sensor. In some examples, the system may also use a doppler effect to determine a direction of travel of a user and/or item relative to an RFID sensor or read zone.

Using these determinations, the system may determine whether the user was in possession of the item when exiting the facility. For example, the system may determine one or more probabilities, such as a confidence level, that the user was in possession of the item when exiting the facility. For a probability, the system may increase the probability each time that the system determines that the item was located proximate to the user at a given time and decrease the probability each time the system determines that the item was not located proximate to the user at a given time. In some instances, the system may weigh certain locations more than other locations. For example, the system may give more weight when increasing the probability after determining that the item was located proximate to the user at a time that the user was exiting the facility. This is because these determinations may better indicate that the user was actually in possession of the item when exiting the facility.

For an example of determining a probability, the system may determine that the item was located proximate to the user at a first time (e.g., when the item was picked up from the inventory location). As such, the system may determine that there is a 50% probability that the user was in possession of the item. The system may then determine that the item was located proximate to the user at a second, later time in a first RFID zone. As such, the system may determine that there is a 70% probability that the user was in possession of the item. Next, the system may determine that the item was located proximate to the user at a third, later time at a second RFID zone. The third time may correspond to when the user exited the facility and as such, the system may provide more weight to this determination. As such, the system may determine that there is a 99.9% probability that the user was in possession of the item when exiting the facility.

By tracking a location of the user using the vision system, the system may determine a first path or track for the user. Additionally, by tracking the identification of RFID tags at RFID zones within the facility, a path or sequence of passing through the RFID zones may be built. The system may then correlate the path for the user from the vision system with the sequence of RFID zones and RFID tags identified to determine and/or increase a probability or confidence that a particular item is associated with a particular user. In some examples, the system may determine with a single read through an RFID zone that that the user is in possession of an item with at least a threshold level of confidence.

The system may then use the probability to determine whether the user was in possession of the item at the time of exiting the facility. In some instances, the system may determine that the user was in possession of the item when the probability satisfies (e.g., is equal to or greater than) a threshold probability (e.g., 98%, 99%, etc.), and determine that the user was not in possession of the item when the probability does not satisfy (e.g., is less than) the threshold probability. For example, and using the example above, the system may determine that the user was in possession of the item when exiting the facility based on the 99.9% probability satisfying a threshold probability of 99%. As will be discussed in more detail below, when the system determines that the user was in possession of the item, the system may store data representing an identifier of the item in association with the account of the user and/or process a transaction for a price of the item.

In some instances, in addition to, or alternatively from, using the locations of the user and the locations of the item to determine whether the user was in possession of the item when exiting the facility, the system may use direction(s) of movement of the user and direction(s) of movement of the item. For example, the system may use the locations of the user within the facility to determine the direction(s) of movement of the user within the facility. For instance, the direction(s) of movement may indicate that the user walked north within the facility for a first distance and/or during a first time, then walked west within the facility for a second distance and/or during a second time, then walked southeast within the facility for a third distance and/or during a third time, and then walked south within the facility for a fourth distance and/or during a fourth time. In some examples, the system may also determine a direction a user and/or item is traveling through a sensor read zone. By identifying users and items directions of travel through a read zone, the users may be correctly identified with associated users even though multiple users and items may be present in the read zone together.

The system may also use the locations of the item within the facility, based on the sequence of the RFID zones the item passes through to determine the direction(s) of movement of the item within the facility. The system may then use the direction(s) of movement of the user and the direction(s) of movement for the item to determine that the user was in possession of the item when leaving the facility.

For example, the system may determine that, during the second time, the user and the item moved in approximately the same path based on the user's path passing through the RFID zones in the same sequence and at the same time stamps as the item was identified as being within the RFID zones.

In some instances, the system may perform similar processes to determine whether one or more additional users were in possession of the item when exiting the facility. For example, the system may analyze the sensor data described above to determine one or more times that the item was located proximate to a second user (and/or associate) within the facility and/or one or more times that the item was not located proximate to the second user within the facility. The system may then use these determinations to determine one or more probabilities for the second user.

For example, and using the example above with the user, the system may determine that the item was located proximate to the second user at the first time (e.g., when the item was pickup up from the inventory location). As such, and similar to the user, the system may determine that there is a 50% probability that the second user was in possession of the item at the first time. The system may then determine that the item was not located proximate to the second user at the second time. As such, the system may determine that there is a 30% probability that the second user was in possession of the item at the second time. Next, the system may determine that the item was not located proximate to the second user at a fourth time. The fourth time may correspond to when the second user leaves the facility and as such, the system may provide more weight to this determination. As such, the system may determine that there is a 1% probability that the second user was in possession of the item when exiting the facility. The system may then determine that the second user was not in possession of the item when exiting the facility based on the probability of the second user being less than the probability of the user and/or based on the probability of the second user not satisfying the threshold probability.

In some instances, the system may use locations of other objects within the facility to determine that the user was possession of the item when exiting the facility. For example, the user may use a tote, such as a shopping cart, while in the facility. Similar to the item, the tote may also include a tag or RFID device that outputs signals that the system may use to determine the locations of the tote within the facility, such as when the tote and/or cart passes through the RFID zones. The system may then determine that the tote is associated with the user. In some instances, the system makes the determination based on the locations of the tote being proximate to the locations of the user when identified within the RFID zones, similar to the processes described above with respect to the item. Additionally, or alternatively, in some instances, the system makes the determination based on analyzing sensor data (e.g., image data) and, based on the analysis, determining that the user is in possession of the tote (e.g., determining that the user was located proximate to the tote while within the facility).

In some instances, the system may use one or more additional sensors when determining whether the user was in possession of the item. For example, when the user initially removes the item from the inventory location, a sensor, such as a weight sensor, may send sensor data to the system. The system may analyze this sensor data to determine that the item was removed from the inventory location at a given time. The system may also analyze the first sensor data to determine that the user was located proximate to the inventory location at the given time (e.g., using similar processes as the system uses to determine that the item was located proximate to the user, which are described above). As such, the system may determine that it was the user that removed the item from the inventory location. The system may use this determination when determining the probability that the user was in possession of the item when exiting the facility. For example, the system may increase the probability.

For more detail about the facility, customized retail facilities include inventory locations housing one or more items that may be ordered, received, picked, and/or returned by users. These inventory locations may be associated with one or more sensors configured to generate sensor data indicative of events that occur with respect to the items housed thereupon. For example, these sensors may generate sensor data indicative of a user (and/or associated of the facility) removing an item from the inventory location, returning the item to the inventory location, and/or the like. These sensors may include overhead cameras, in-shelf cameras, weight sensors, and/or any other type of sensor configured to generate sensor data indicative of user interactions with the items. An inventory management system (e.g., the system) may communicate with the sensors in order to receive the sensor data.

In addition, the facility may include, in some instances, one or more entry locations for entering the facility and one or more exit locations for exiting the facility. For example, the facility may include an AC entry location at which an entering user provides information for identifying an account of the user. For instance, the AC entry location may include a scanner or other imaging device at which an entering user scans or otherwise provides a unique code associated with the account of the user, such as a code displayed on a mobile device of the user. Or the entry location may include a microphone, camera, or other sensor that generates sensor data at the request of the user for use in identifying the account of the user. In still other instances, the AC entry location may include an input device for reading information from a payment card of a user, such as a credit card, debit card, prepaid card, etc. For example, the AC entry location may include a scanner or camera that scans or captures an image of a payment card, a card reader that receives information from a payment card via a swipe, dip, tap, or the like, or may include any other type of input device configured to receive payment or account information.

In some instances, the account of the user may be associated with a payment instrument of the user such that the payment instrument is able to be charged for items procured by the user, with the charge occurring automatically upon exit of the facility by the user and without the user needing to engage in a manual checkout process of the items. Accordingly, the facility may include an AC exit location where an exiting user provides information for identifying an account of the exiting user. The AC exit location may include, similar to the AC entry location, a scanner or other imaging device at which the exiting user scans or otherwise provides a unique code associated with the account of the user, such as the code displayed on the mobile device of the user. Or the AC exit location may include a microphone, camera, or other sensor that generates sensor data at the request of the user for use in identifying the account of the exiting user.

Note that the facility may also include entry and exit locations at which users may enter and exit without providing identifying information. For instance, users may be allowed access to the facility in a manner similar to a traditional retail facility to allow users to shop or otherwise interact with items at the retail facility without needing to provide information for identifying user accounts. In some examples, the user may be allowed to enter the facility, then provide information for identifying a user account at an ordering location within the facility. Also, at least one exit location may resemble a traditional exit location at a retail facility, including an associate of the facility operating a point of sale (POS) device to manually check out the exiting user, such as an exiting user wishing to pay for items in cash. Of course, it is to be appreciated that the facility may include self-checkout kiosks or any other technology for enabling manual checkout of the items within the facility.

Within this example facility, if a user enters through an AC entry location and provides information identifying an account of the user, or the user enters the facility and provides information identifying the account of the user at an ordering location, then the system associated with the facility may generate a record indicating the presence of the user at the facility. The record may store an indication of the identity of the user, as well as an indication of whether the user is currently eligible to exit the facility (with items procured by the user) via the AC exit location.

Upon finishing his or her shopping, the user may approach the AC exit location and, in some instances, scan or otherwise provide identifying information to enable the system to identify the exiting user. After scanning his or her unique code at the AC exit location, for instance, the user may exit the facility. The system, meanwhile, may thereafter charge an account of the identified exiting user for a price of the items procured by the user within the facility. Of course, while the above example describes the user scanning a unique code (e.g., via a mobile device of the user), it is to be appreciated that the exiting user may be identified based at least in part on other sensor data, such as image data, voice data, or the like.

While some of the examples below are described with reference to a materials handling facility (e.g., a brick-and-mortar retail store, a fulfillment center, etc.), the systems and techniques may be implemented for detecting events in any type of facility, an airport, a classroom, an outdoor environment, an amusement park, or any other location. Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

As described herein, a threshold distance may include, but is not limited to, one meter, two meters, five meters, and/or any other distance. Additionally, a threshold period of time may include, but is not limited to, five minutes, ten minutes, thirty minutes, and/or any other time period.

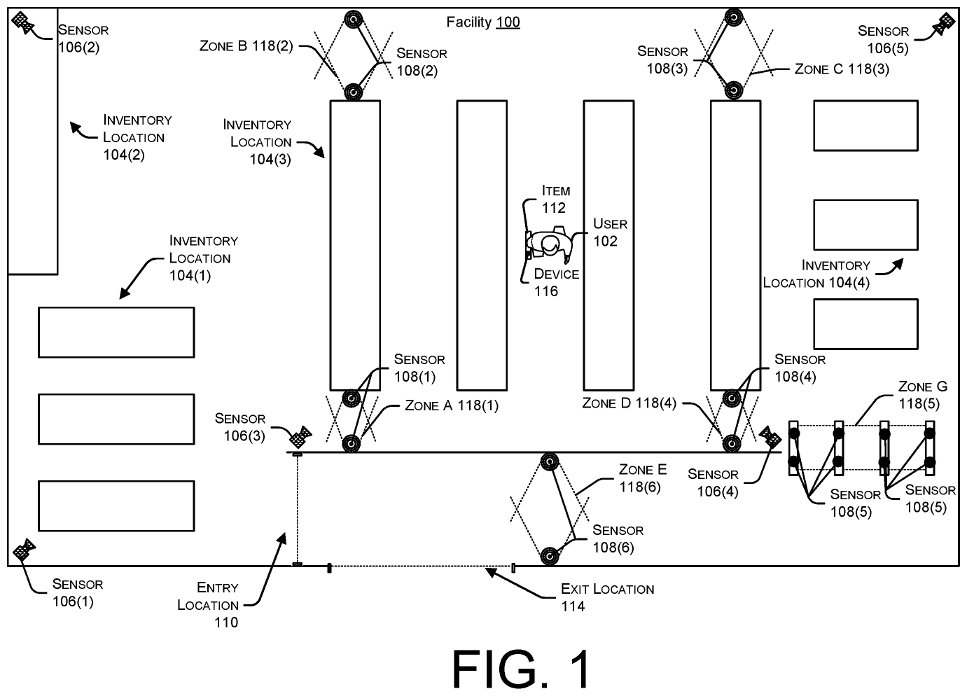

FIG. 1 illustrates a facility 100 associated with a system for enabling automated checkout (AC) techniques to allow users, such as a user 102, to enter the facility 100, order and/or pick one or more items, and exit the facility without performing a manual checkout of the items. To do so, the system coupled to the environment may identify the user 102 and charge an account associated with the user 102 for a price of the ordered and/or picked items upon exit of the user 102.

As illustrated in FIG. 1, the facility 100 includes inventory locations 104(1)-(4) (also referred to as “inventory locations 104”). For example, the inventory locations 104(1) and (4) may include racks that hold items (e.g., clothes), the inventory locations 104(2) and (3) may include tables that hold items (e.g., sporting equipment). While these are just a couple examples of inventory locations 104 that may be located within the facility 100, in other examples, the facility 100 may include any number and/or type of inventory locations. In some examples, the inventory locations 104 may include shelving in a grocery store, with tables at inventory location 104(1), refrigerated coolers at inventory location 104(2), shelving at inventory location 104(3), and further shelving at inventory location 104(4).

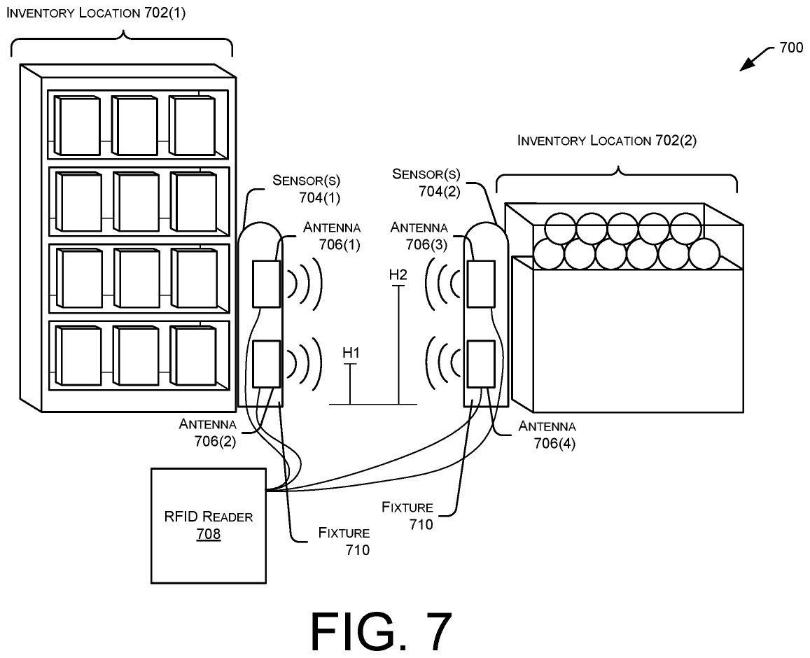

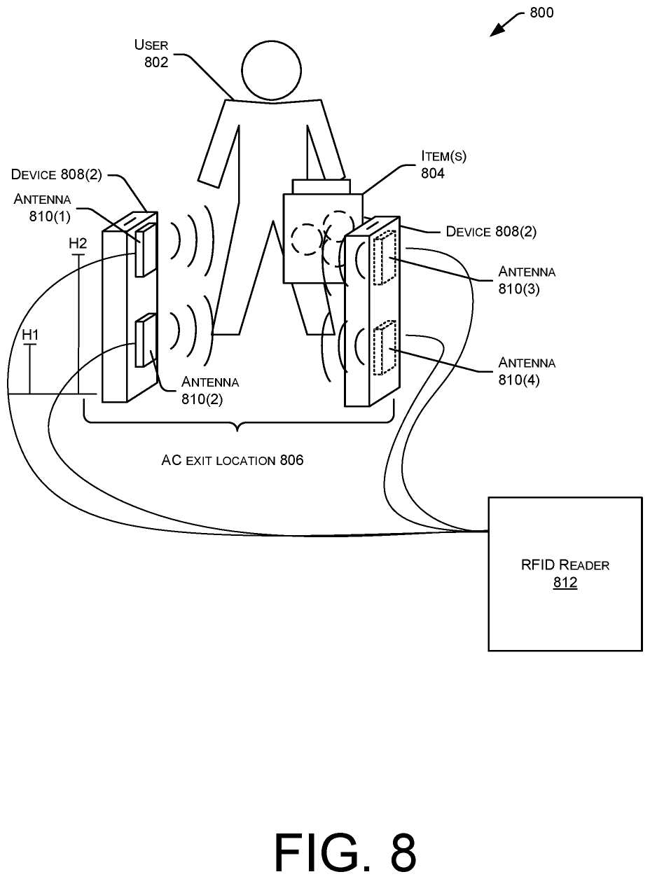

The facility 100 may also include sensors 106(1)-(5) (also referred to as “sensors 106”) and sensors 108(1)-(5) (also referred to as “sensors 108”) located throughout the facility 100. In the example of FIG. 1, the sensors 106 may include cameras and the sensors 108 may include signal readers, such as RFID readers as shown and described with respect to FIGS. 7-8. However, in other examples, the sensors 106 and/or the sensors 108 may include any other type of sensor, such as microphones, weight sensors, and/or the like. Additionally, in other examples, the facility 100 may include any number of the sensors 106 and/or any number of the sensors 108. For example, the facility 100 may only include the sensors 108 at the entrance/exit of the facility 100. In some examples, the sensors 106 and sensors 108 may be positioned in a fixture (e.g., post, shelf, table, counter), a ceiling, a floor, a display, or other such location within the facility. Though the sensors 108 are depicted in pairs, the sensors 108 may be individual sensors defining the read zones.

The sensors 108 define RFID zones, zones 118(1)-118(6) (also referred to as “zones 118”). The zones 118 include locations where the sensors 108 are configured to read RFID information from items as they are within the zones 118. In the example of FIG. 1, the zones 118 are positioned such that a user entering at entry location 110 will pass through multiple zones 118 throughout the store before reaching the exit location 114. The zones 118 are positioned at the intersections of aisles and at the route to the exit location 114 such that the user 102 will pass through one or more zones 118 to reach the exit location, thereby increasing the number of times that items may be identified with the user based on their associated RFID tags.

In the example of FIG. 1, upon the user 102 entering the facility 100 via an entry location 110 and at a first time (T₁), the system may generate a record indicating an identifier associated with the user 102. This record may be continuously or periodically updated by a locating component of the system to generate current location data of the user 102 within the facility 100, at the prior consent/request of the user 102. For example, the system may receive, from the sensors 106 (e.g., the sensor 106(1)), sensor data representing the user 102 at the first time T₁. The system may then analyze the sensor data to determine that the user 102 was located at a first location within the facility 100 at the first time T₁. Additionally, the system may receive, from the sensors 108 (e.g., the sensor 108(2)), sensor data representing an item 112 at the first time T₁. The system may then analyze the sensor data to determine that the item 112 was located at a second location within the facility at the first time T₁. The item 112 may be identified based on a device 116, such as an RFID tag detectable by the sensors 108.

In some instances, the system may be generating timestamps indicating at least the locations of the user 102 and/or the locations of the item 112. For example, the system may generate timestamps indicating that the user 102 was located at a first location at a first time T₁, the user 102 was located at a second location at the second time T₂, the user 102 was located at a third location at a third time T₃, etc. Additionally, the system may generate timestamps indicating that the item 112 was located at the locations indicated by the zones 118 when the item 112 is detected by the sensors 108.

As further illustrated in the example of FIG. 1, the item 112 includes a device 116, such as a tag (e.g., an RFID tag), the transmits signals (e.g., data) that are received by the sensors 108. In some instances, the device 116 transmits the signals at a given frequency. Additionally, or alternatively, in some instances, the device 116 transmits the signals after receiving signals from the sensors 108. In either of the instances, the signals may represent at least an identifier associated with the device 116, where the system can use the identifier to identify the device 116 and/or the item 112. In some instances, the signals may further represent an identifier associated with the item 112.

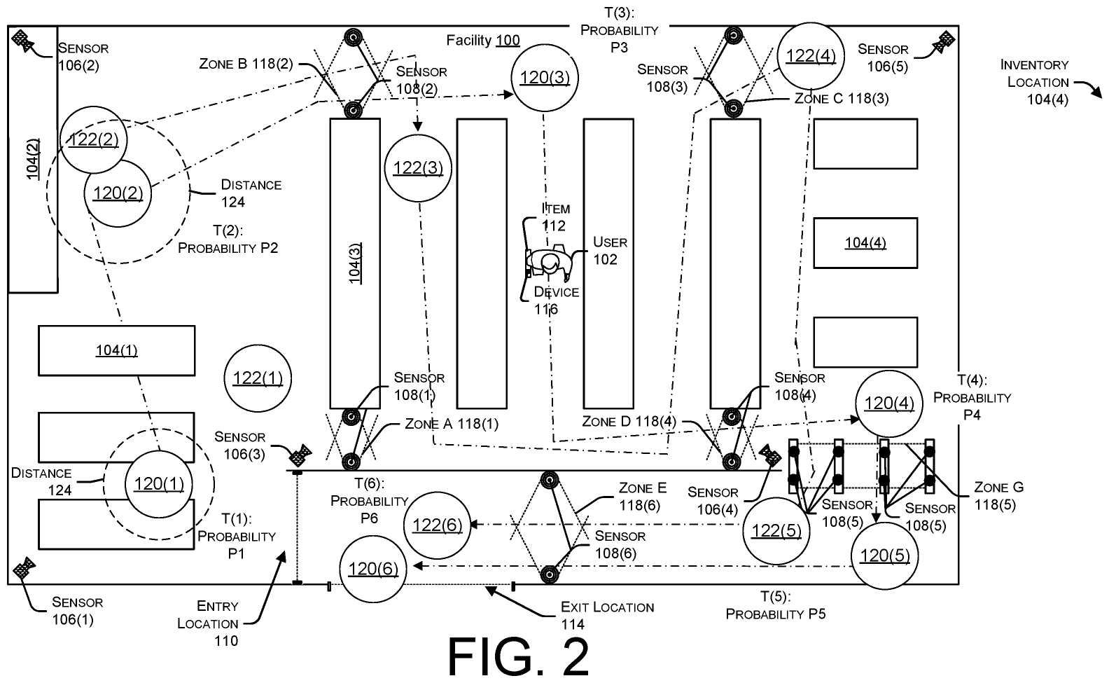

FIG. 2 illustrates an example of the system determining that the user 102 was in possession of the item 112 using directions of movement of the user and the item, according to at least one example. The facility 100 includes the elements shown and described with respect to FIG. 1 and shows an example path for multiple users to traverse the facility 100 as they interact with items. For example, FIG. 2 illustrates the locations 120(1)-(6) (also referred to as the “locations 120”) of the user 102 as detected by the system while the user 102 was navigating through the facility 100. Additionally, FIG. 2 illustrates the locations 122(1)-(6) (also referred to as the “locations 122”) of a second user as detected by the system while the second user was navigating through the facility 100. The system may use the locations 120 of the user 102 and the locations 122 of the second user as well as the locations of items, such as item 112, as they pass through the zones 118 to determine that the user 102 or the second user was in possession of the item 112 while within the facility 100 and/or when exiting the facility 100.

At a first time T₁ the system may identify the user 102 entering through the entry location and viewing the inventory location 104(1). The user may interact with one or more items from the location, and the sensors 106 may identify the items based on the items being interacted with within a threshold distance 124 to the location 120(1) of the user 102 at the first time T₁. Based on the determination, the system may determine that there is a 0% probability that the user 102 was in possession of the item 112 at the first time T₁.

The system may then determine that the user 102 proceeded to location 120(2) at a second time T₂. In some instances, the system makes the determination based on the location 120(2) based on data from the sensor 106(2). The user 102 may interact with one or more items at inventory location 104(2). In some examples, inventory location 104(2) may include items such as meat products that are sold based on weight, and are therefore of varying prices though appearing nearly identical to the sensors 106. At the second time T₂ the system may determine that there is a 50% probability that the user 102 was in possession of the item 112 at the second time T₂ based on observed interactions by the sensors 106.

The second user, may enter through the entry location 110 and at or near the first time may be at location 122(1). The second user may then proceed to the location 122(2) and interact with the inventory location 104(2) at or near the second time T₂ based on observed interactions by the sensors 106. Due to the highly individual nature of the items that may be stored at the inventory location 104(2) and/or because of the near simultaneous interaction from the user 102 and the second user with the items, the system may not be able to differentiate an item selected by the user 102 and the second user and may need to disambiguate which item was selected by each user. In some examples, at the second time T₂ the system may determine a probability that the first user has the item 112 and/or that the second user has the item 112. In some examples, the probability may be below a threshold value such that the system lacks a confidence level threshold to cause a transaction to take place due to the ambiguity surrounding which individual selected which item.

Next, the system may determine that the user 102 and the second user pass through zone B 118(2). The item 112 may be identified by the sensors 108(2) as it passes into and through zone B 118(2). Accordingly, using the sensors 106 and the sensors 108(2), the system may be able to identify a first timestamp when the user 102 passes through zone B 118(2), a second timestamp when the item 112 passes through zone B 118(2), and a third timestamp when the second user passes through zone B 118(2). Based on the timestamps, the system may be able to either increase and/or decrease a probability that the user 102 or the second user was in possession of the item 112. For example, in response to identifying that the first timestamp and the second timestamp were within a threshold amount of time (e.g., within a matter of less than one to several seconds), the probability that the user 102 is in possession of the item may be increased. Additionally, in response to determining that a difference between the second timestamp and the third timestamp exceeds a threshold amount (e.g., in a range of a more than two seconds), the system may decrease a probability that the second user is in possession of the item 112.

As the user 102 and the second user proceed through the facility 100 to the locations 120 and 122, the probability that the user 102 and/or the second user is in possession of the item 112 may be adjusted as described above. In some examples, the system may further determine that the second user was at location 122(4) and passed through zone C 118(3) while the item 112 did not pass through zone C 118(3), and may therefore decrease a probability that the item 112 is with the second user. Upon reaching zone G 118(5), the user 102 and the second user may be directed through different lanes of zone G 118(5), with the different lanes associated with sensors 108(5). Based on identifying the user 102 and the item 112 passing through the same lane at zone G 118(5), the probability that the user 102 is in possession of the item 112 may be increased. Additionally, identifying that the second user passed through a different lane than the item 112, the probability that the second user has the item 112 may be decreased. The timestamps at a third, fourth, fifth, and sixth time may be further used to increase and/or decrease a probability that the user 102 and/or the second user is in possession of the item 112.

In some examples, the system may use the routes of the user 102, the second user, and the item 112 to determine whether the user 102 or the second user was in possession of the item, or to increase and/or decrease a probability of the same. In such examples, the route that the user 102 takes through the facility 100 may be tracked using the sensors 106 and the sequence of the zones 118 that the item 112 passes through may be logged based on RFID data as the item 112 passes through the zones 118. In some examples a first route may be determined based on the tracking of the user 102. A second route may be determined based on the tracking of the second user through the facility. A sequence for the item 112 may be determines based on the zones 118 through which the item 112 passes. The sequence may be compared against the first route and the second route to determine a probability that the item 112 is with the user 102 and/or the second user.

In some examples, the user 102 may be carrying multiple items and/or moving a cart or tote containing multiple items. In some examples, the items may all pass through the zones 118 together and be read by the sensors 108 together at the same locations. In this manner, the collection of items may be confirmed and/or a probability that the user 102 is associated with the items may be increased.

In some instances, the system may then determine that the user 102 was in possession of the item 112 when exiting the facility based on the 99.9% probability satisfying a threshold probability, such as 99%. The system may then store data (e.g., event data) that associates an identifier of the item 112 with the account of the user 102. Additionally, the system may use payment information, which may be stored in association with the account of the user 102, to process a transaction for a price of the item 112.

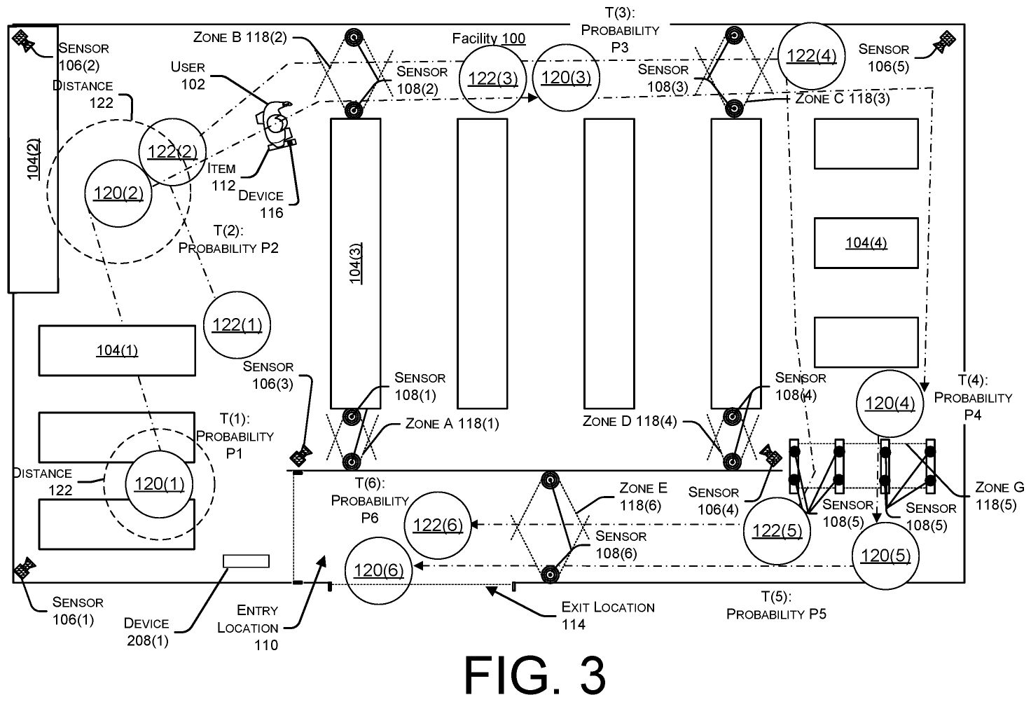

FIG. 3 illustrates an example of the system determining that the user was in possession of the item using timed entries into sensor regions, according to at least one example. In FIG. 3, the facility 100 is laid out as described above, but illustrated in an example where the user 102 and the second user may follow a similar and/or identical route through the facility 100.

In the example of FIG. 3, the system may use the timestamps of the users passing through the zones 118 compared against the timestamps when the item 112 passes through the zones 118 to determine and/or adjust a probability that the user 102 or the second user is in possession of the item. The timestamps may include an entrance and an exit time into the zones 118 describing when a user entered and exited the zone as well as when an item is detected within a zone 118 and no longer detected within the zone 118. In some instances, the user 102 and the second user may pass through a nearly identical route through locations 120(1)-(4) and locations 122(1)-(4) to reach zone G 118(5). In some examples, the user 102 and the second user may pass through the zones 118 at or near the same time as one another such that an overlap in timestamps exists between when the user 102 enters a zone but has not yet exited the zone by the time the second user enters the zone.

Upon reaching zone G 118(5), the users may pass through different lanes as described herein. Upon reaching zone G 118(5), the user 102 and the second user may be directed through different lanes of zone G 118(5), with the different lanes associated with sensors 108(5). Based on identifying the user 102 and the item 112 passing through the same lane at zone G 118(5), the probability that the user 102 is in possession of the item 112 may be increased. Additionally, identifying that the second user passed through a different lane than the item 112, the probability that the second user has the item 112 may be decreased.

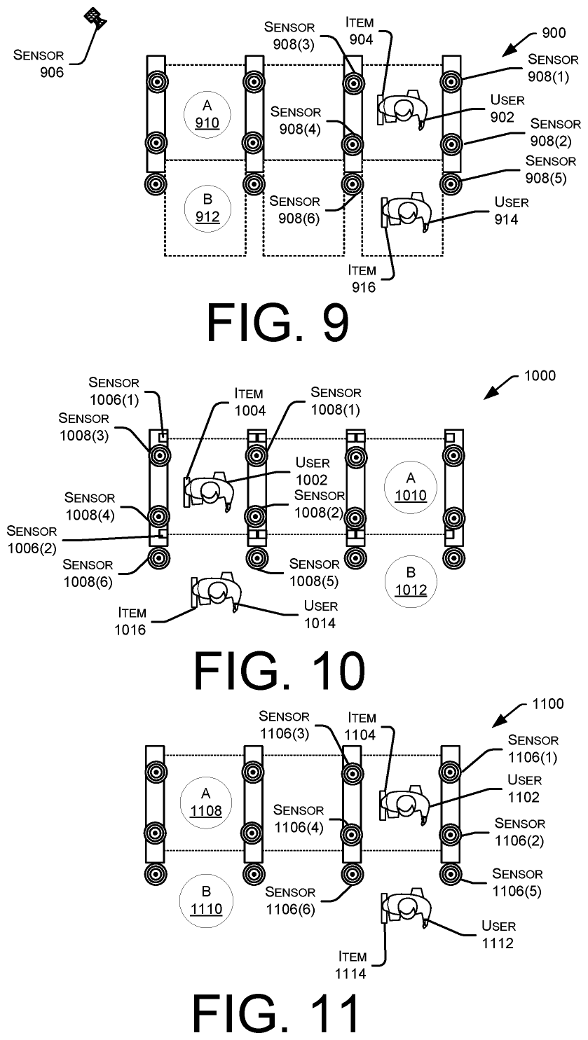

In some examples, the users may pass through zone G 118(5) separated by some period of time, identifiable by a timestamp. In some examples, such as shown and described with respect to FIGS. 9-11, the gates of zone G 118(5) may include a physical barrier or visual indicator directing users to proceed or pause before proceeding through the lanes. In such examples, the system may ensure that the user 102 has exited zone G 118(5) before the second user enters, thereby increasing the likelihood that the system will be able to detect whether the item 112 is with the user 102 or the second user.

In some examples, the system may identify the users based on a distance to the sensors 108. In such examples, the system may determine a distance from a user to the sensor 108 of a particular read zone using the sensors 106. The sensors 108 may also have a signal strength or distance component representative of a distance of an RFID tag to the sensor 108 based on a signal strength or return signal of the RFID signal. By correlating the distance from the vision system and the RFID sensors, the system may identify the users and items distinctly.

In some examples, the system may then determine that the user 102 was in possession of the item 112 when exiting the facility based on the 99.9% probability satisfying a threshold probability, such as 99%. The system may then store data (e.g., event data) that associates an identifier of the item 112 with the account of the user 102. Additionally, the system may use payment information, which may be stored in association with the account of the user 102, to process a transaction for a price of the item 112.

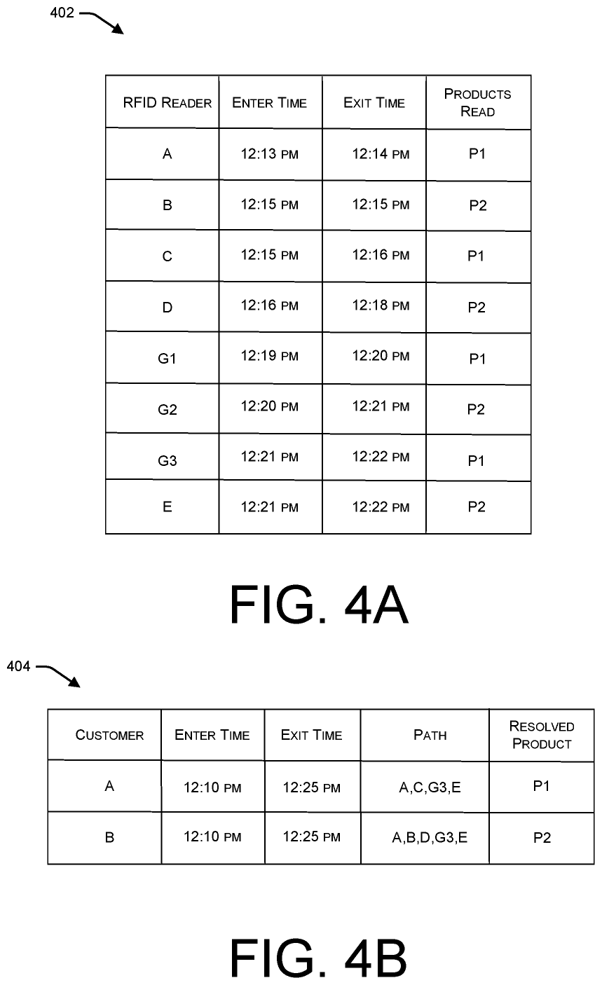

FIGS. 4A-4B illustrate examples of the type of information that may be included in timestamps for an item, according to at least some examples. As shown, timestamp data 402 may represent at least a sensor identifier (e.g., RFID reader), an enter time, an exit time, and product identities read. The sensor identifier may identify the sensor that detected the device. The enter time and the exit time may indicate a time that the item was first detected by the sensor, such as when the item enters the zones 118 of FIG. 1 and when the item leaves the zones 118 and is therefore no longer detected as the exit time. The products read may include RFID data for one or more items detected within the zones 118 during the time period at the RFID reader. In some examples, the products read may be identified at the RFID readers and a sequence of RFID readers may be determined for each of the items, with corresponding timestamps for the sequence of RFID readers encountered by the items. The sequence may be used to determine the route of the item through a facility based on the known location of the RFID readers. The RFID reader data may indicate which zone of the facility the sensor is located within that detected the signal. The X-location, Y-location, and Z-location may represent the coordinates within the facility at which the device was located. may indicate a greater likelihood that the sensors did receive a signal from the device.

The customer path data 404 may include a customer identifier, which may identify a customer account, such as may be linked to a virtual cart or other such system. The customer path data may also include an enter time and an exit time indicating a time when the user entered the facility and exited the facility. The customer path data 404 further includes path information describing the route of the customer through the facility. In some examples the path may be represented as the sequence of the zones 118 that the customer passed through, with corresponding timestamps. In some examples, the path information may include more specific path information such as map data, directional data (e.g., moved northeast 10 m, moved west 3 m, etc.). The path information may be used to compare against the timestamp data 402 for the items to determine and/or adjust a probability that the customer has a particular item in their possession. In some examples two customers may have a nearly identical path through the facility at nearly the same time, such as when two friends shop together. However, as described above, at the exit gates, the customers may be differentiated.

The comparison of the path from the customer path data 404 and the timestamp data of the RFID readers may be compared through the use of one or more algorithms that may map the paths of the customers in near real-time and map the sequence for the items and perform a matching algorithm or process to identify when customers and items appear to be following the same path based on the two sets of data, and thereby increase a probability that the customer has a particular item in their possession.

In some examples, the system may determine the association of a customer with items based on the timestamp data and the customer path data 404. The system may determine such associations by providing the timestamp data 402 and the customer path data 404 to a machine learning model trained to determine correlation and association between items and users based on the data. In some examples, the system may use a probabilistic model for making such a determination. In some examples other statistical models and/or heuristic models may be used for determining the association.

While these are simplified examples of the type of information that may be stored with respect to the customers and the items as they move through the facility, in some examples additional data may be stored, in other examples, the timestamp data 402 or the customer data may not include at least some of the information.

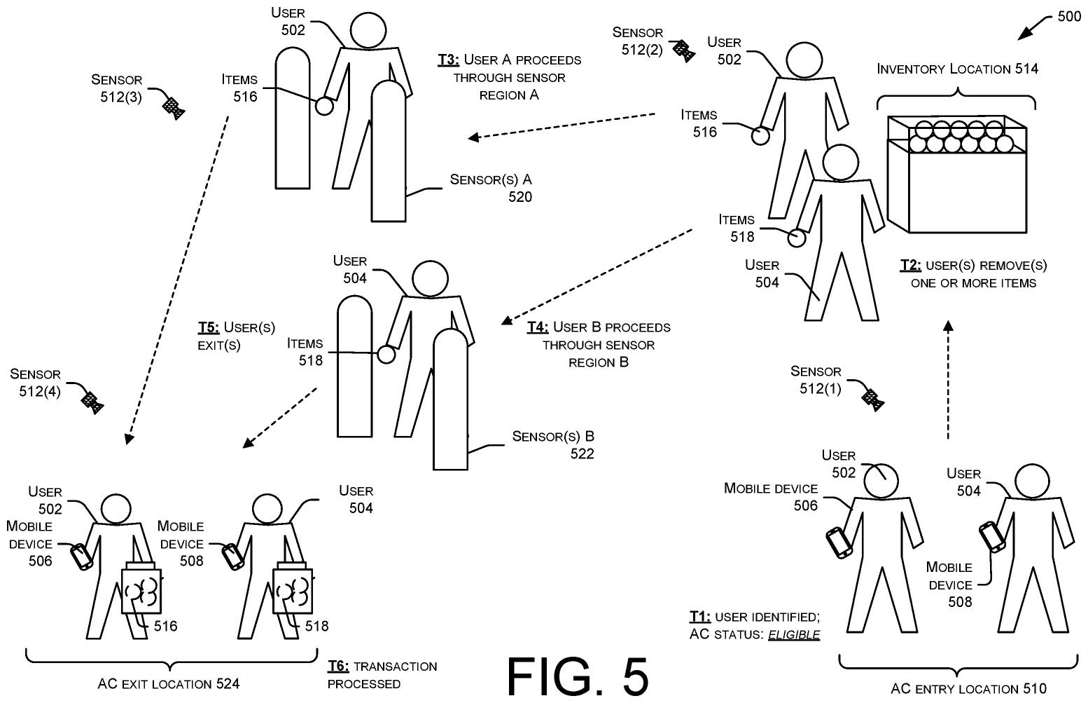

FIG. 5 illustrates a facility 500 associated with a system for enabling automated checkout (AC) techniques to allow users, such as a user 502 and a user 504, to enter the facility 500, order and/or pick one or more items, and exit the facility without performing a manual checkout of the items. To do so, the system coupled to the environment may identify a user and charge an account associated with the user for a cost of the ordered and/or picked items upon exit of the user.

As illustrated in FIG. 5, the facility 500 includes an AC entry location 510 and an AC exit location 524. The facility 500 also includes an inventory location 514. In some examples, the facility 500 may also include sensors 512(1)-(4) (also referred to as “devices 512”), which may include various types of scanning devices and/or electronic devices to help facilitate AC techniques, which will be described in more detail below. The facility 500 may also include sensors 520 and 522. The sensors 520 and 522 may include RFID sensors or other such sensors as described herein. In general, the sensors 512 and/or the sensors 520 and 522 may be associated with the AC entry locations 510, the AC exit locations 524, and/or the inventory location 514.

The AC entry location 510 (e.g., entry gate) may request that entering users provide identifying information prior to entering the facility 500. In the illustrated example, the user 502 and the user 504 enters through the AC entry location 510 by scanning a unique code presented on a mobile device 506 of the user 102 or a mobile device 508 f the user 504, such as at a scanning device at the AC entry location 510. The scanning device may provide this information to a system, such as an inventory management system discussed in following figures, which may use this information for identifying the entering users 502 and 504. Of course, while this example describes identifying the users 502 and 504 based at least in part on the users 502 and 504 scanning a unique code presented on the mobile devices 506 and 508, the system may additionally, or alternatively, identify the users 502 and 504 based on voice data (e.g., the user 502 stating his or her name), image data (e.g., image data of a face of the user 502), password data (e.g., an alphanumeric string), credit card data, and/or any other type of data. For instance, the system may identify the user 502 based on data provided by sensor 512(1), or based on credit card data provided by a device at the AC entry location 510. In some examples, those users that have consented/requested to take part in the AC techniques may be identified, while the system may refrain from identifying other users entering the facility 500. As suggested above, in some examples a facility may not have specified entry locations or gates.

In the scenario illustrated in FIG. 5, upon the user 502 entering the facility 500 via the AC entry location 510 at a first time (T₁), the system generates a record indicating the presence of the identified user 502 within the facility 500. This record may be continuously or periodically updated by a locating component of the system to generate current location data of the user 502 within the facility 500, at the prior consent/request of the user 502. In some instances, the sensors 512, such as overhead cameras or the like, may be used to determine a current location of the user 502. In addition, the record generated by the system at T₁ may indicate whether the user 502 is eligible to engage in the AC techniques provided by the facility 500. For example, the record may indicate whether the user 502 is able to “just walk out” with any items he or she collects within the facility 500 without first performing a manual checkout for the items. In this example, at least in part because the system has identified the user 502, the user 502 is eligible at T₁ to exit the facility 500 with item(s) without performing manual checkout of the items.

Further, upon the user 504 entering the facility 500 via the AC entry location 510 at the first time (T₁), the system generates a record indicating the presence of the identified user 504 within the facility 500. This record may be continuously or periodically updated by a locating component of the system to generate current location data of the user 504 within the facility 500, at the prior consent/request of the user 504. In some instances, the sensors 512, such as overhead cameras or the like, may be used to determine a current location of the user 504. In addition, the record generated by the system at T₁ may indicate whether the user 504 is eligible to engage in the AC techniques provided by the facility 500. For example, the record may indicate whether the user 504 is able to “just walk out” with any items he or she collects within the facility 500 without first performing a manual checkout for the items. In this example, at least in part because the system has identified the user 504, the user 504 is eligible at T₁ to exit the facility 500 with item(s) without performing manual checkout of the items. In some examples, the user 502 and the user 504 may enter at different times, or may enter simultaneously at the first time.

In some instances, the system may, additionally or alternatively to the user 502 and/or the user 504 being identified, store an indication that the user 502 and/or the user 504 is eligible to exit the facility without performing manual checkout of the items based on the user being associated with a payment instrument. For example, upon identifying the user 502 entering the facility 500, the system may identify an account of the user 502 and may determine whether the account is associated with a valid payment instrument. If so, then the system may store an indication that the user 502 is eligible to exit the facility 500 with one or more items without performing a manual checkout of the items. In another example, the entering user 502 may swipe, scan, or otherwise provide identifying information associated with a payment instrument (e.g., credit card) of the user 502 upon entering the facility 500. The system may use this identifying information to determine whether the payment instrument is valid (potentially along with a limit of the payment instrument) and may store an indication that the user 502 is eligible to exit the facility 500 without performing manual checkout of the items (assuming the total of the items is less than the limit). In these instances, the system may or may not identify the user 502 but may instead simply associate the user 502 in the facility 500 with the identified payment instrument. In yet another example, the AC exit location 524 may include a device configured to accept cash, such that the user 502 may input a certain amount of cash and remain eligible for exiting the facility 500 without performing a manual checkout exit, so long as the user 502 does not obtain items having a cumulative value (e.g., with taxes, etc.) that exceeds the amount of inserted cash.

Returning to the scenario of FIG. 5, in this example the user 502 and the user 504 enters the facility 500 and proceeds to the inventory location 514. As such, and at a second time (T₂), the user 502 removes a number of items 516 from the inventory location 514 and the user 504 removes a number of items 518 from the inventory location 514. The system may receive sensor data, such as image data generated by the sensor 512(2) located proximate to the inventory location 514. In some instances, the system may then analyze the sensor data to determine that the sensor data represents the user 502 and/or the user 504 removing the items 516 and items 518 from the inventory location 514. However, in other examples, the system may use other types of sensor data to identity the items 516 and items 518 being removed by the user 502 and the user 504. For example, the system may use sensor data from a weight sensor located within the inventory location 514, where the sensor data indicates that the items 516 and items 518 were removed from the inventory location 514 when the user 502 and the user 504 were positioned around the inventory location 514.

In some examples, because the user 502 and the user 504 were both at the inventory location 514, the system may not be able to determine, with more than a threshold probability, that user 502 selected items 516 and user 504 selected items 518. In some examples, every item removed by a user may have a corresponding probability that a particular user is the one who removed the item. After the user 502 and the user 504 retrieve items 516 and items 518, they may proceed through the facility 500. The facility 500 may include sensors 520 and sensors 522, such as shown and described with respect to FIGS. 7-11 herein.

At a third time (T₃), the user 502 may proceed through a zone defined by sensor 520. The system may determine, using the sensor 512(3) that the user 502 is present in the region and may determine, using the sensor 520 that the items 516 are present within the region as the user 502 proceeds through the facility. Based at least in part on the determination that the user 502 and the items 516 are in the region at the same time, a probability that the user 502 has the items 516 in their possession may be increased.

At a fourth time (T₄), in this example, the user 504 may proceed through a zone defined by sensor 522. The system may determine, using the sensor 512(3) that the user 504 is present in the region and may determine, using the sensor 522 that the items 518 are present within the region as the user 504 proceeds through the facility 500. Based at least in part on the determination that the user 504 and the items 518 are in the region at the same time, a probability that the user 504 has the items 518 in their possession may be increased.

At a fifth time (T₅), in this example, user 502 and user 504 exit the facility 500 at the AC exit location 524 by, for example, providing identifying information, or by simply exiting the facility 500 without scanning or providing identifying information. For example, similar to the AC entry location 510, the AC exit location 524 (e.g., exit gate) may include a device that enables the user 502 to scan a unique code from his or her mobile devices 506, or provide any other type of identifying information. In still other instances, the user 502 may walk out and the system may identify the user 502 via facial-recognition techniques using data from sensor 512(4), for example. In such instances, the user 502 may have requested and/or given permission for such automatic recognition techniques. As noted above, in some examples a facility may not have specified exit locations or gates.

In response to the user 502 and/or the user 504 attempting to exit the facility 500, the system may identify the record associated with the user 502 and the record associated with the user 504, determine that the user 502 and/or user 504 is eligible to “just walk out”, and end a shopping session of the user 502 and/or the user 504. At a sixth time (T₆), the system may then process a corresponding transaction, such as charging an account (e.g., a payment instrument, an account previously associated at the system, etc.) of the user 502 and/or the user 504 for the price of the items listed on the virtual cart associated with the accounts of the user 502 and user 504. The transaction processing may also include supplying a notification and/or receipt or other record of the transaction to the users, such as on their mobile devices.

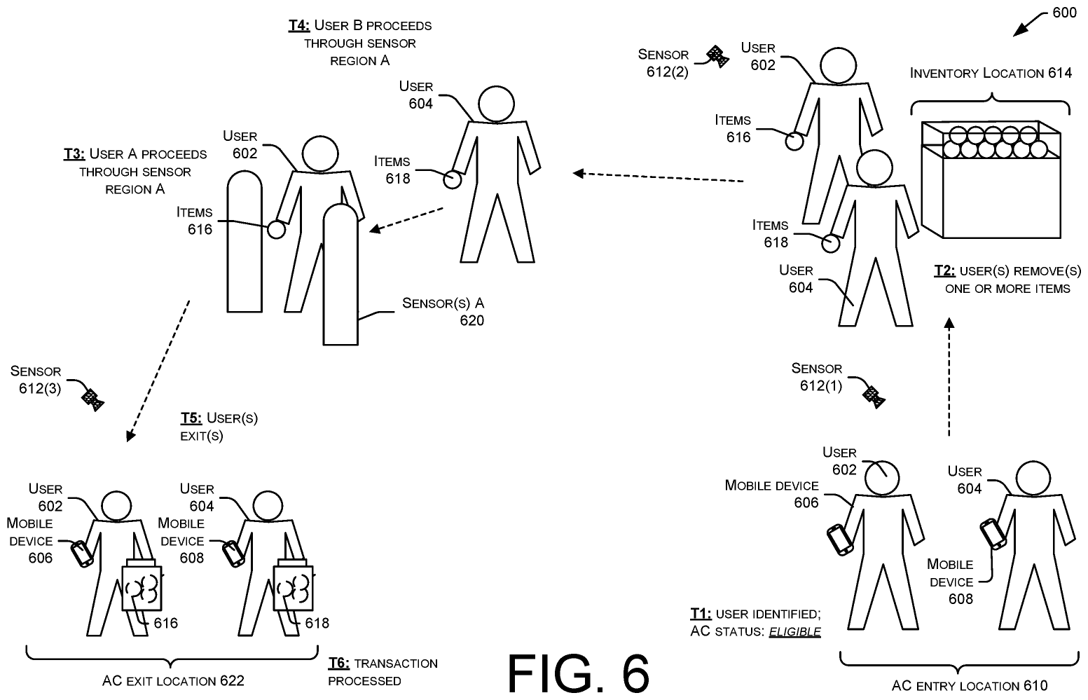

Referring now to FIG. 6, FIG. 6 illustrates an example of a system disambiguating between users collecting items within the facility 600 using timed entries and exits through sensor regions, according to at least one example. The facility 600 includes components similar and/or identical to those described with respect to FIG. 5, including an AC entry location 610, sensors 612, inventory location 614, sensor 620, and AC exit location 622 that correspond to the AC entry location 510, sensors 512, inventory location 514, sensor 520, and AC exit location 524 of FIG. 5.

In the example of FIG. 6, rather than the user 502 and the user 504 taking different paths through the facility 600, they may follow a similar and/or identical path through the store. Accordingly, the system may rely on timestamps associated with the user 602, the user 604, the items 616, and the items 618 passing through the sensor 620. The example of FIG. 6 may be similar to the example of FIG. 5 for the first time, the second time, and the third time. At the fourth time, the user 604 proceeds through the sensor 620 after the user 602. Accordingly a timestamp of the items 618 passing through the sensor is later than a timestamp of the items 616 passing through. Based on data from the sensors 612, the system may determine that the user 602 is associated with the items 616 and the user 604 is associated with the items 618 and/or may increase a probability of the same.

FIG. 7 illustrates an example of a sensor region 700 including RFID sensors 704 for detecting items, according to at least one example. The sensor region 700 may be an example of a zone 118 of FIG. 1. The sensor region 700 is defined by sensors 704(1)-(2) (also referred to as “sensors 704”). The sensor region 700 is positioned between a first inventory location 702(1) and a second inventory location 702(2). The sensor region 700 therefore covers an entire walking space for users in between the inventory locations 702. Though depicted as a particular arrangement of sensors that may be optimized for a grocery setting, the sensor region 700 may be arranged and configured to use antennas 706 arranged in other locations and arrangements. In some examples, the locations may be selected based on expected locations, heights, or regions for an item to pass through the sensor region 700. In some examples, the antennas 706 could be arranged at or above a head height of a user (e.g., in a ceiling or on a fixture at such a height), at a height of a backpack, a hand or arm of a user, and/or other such heights. Additionally, though a first height H1 and a second height H2 are shown, additional antennas may be positioned at other heights that may vary from H1 and H2.

The sensors 704 include antennas 706(1)-(4) (also referred to as “antennas 706”) positioned within fixture 710 and communicably coupled to an RFID reader 708 that communicates with the system to convey RFID information regarding RFID tags read by the sensors 704. The fixtures 710 may be a post or other device or component mounted to a ground within the facility. The fixture may cover the antennas 706 such that the antennas 706 are not visible, but the signals from the antennas pass through the covers to reach the items within the sensor region 700.

The antennas 706 are mounted on both sides of an aisle defining the sensor region 700, with the aisle defining a customer walk through area where users are expected to pass through as they traverse the facility. The fixtures 710 include two antennas 706, positioned at a first height H1 and a second height H2. The first height may be positioned such that it may be aligned with items carried in a tote by a user, and may be in a range of four to twelve inches off the ground. The second height may be positioned such that it may be aligned with items held in the arms of a user and/or carried within a cart associated with a user. The second height may be in a range of fourteen to forty inches off the ground. The height of the antennas increases the chances of reading RFID tags on items by having multiple heights that may align with the tags and may therefore have a stronger signal strength. In some examples, the first height and the second height may correspond to the average height of a bag or tote led by a human with the arm at their side and at a height associated with a cart of a basket.

The sensors 704 are positioned on either side of the aisle such that human body or other objects may not block or shield item tags from being read by the antennas and RFID reader 708 connected therewith. In some examples, the antennas 706 may be positioned at varying angles, such that a first antenna may be directed in a first direction while a second is directed in a second direction. The directions may be based on expected approach and departure angles of users from the sensor region 700. The sensors 704 further provide redundancy in case of hardware failure or other errors to continue to operate if one of the sensors 704 becomes inoperable.

In some examples, the sensors 704 may be used to determine, via the RFID reader, a signal strength of the RFID tag associated with an item. The signal strength may be used to approximate or estimate a distance to the RFID tag, as the distance and signal strength scale proportionally. Accordingly, in an example where two or more users may occupy the sensor region 700, the signal strength of the RFID signals may be used to determine RFID tags closer to one side or region of the sensor region 700 and thereby differentiate between multiple users within the sensor region 700.

FIG. 8 illustrates an example of a sensor region 800 including RFID sensors for detecting items at an exit of the facility, according to at least one example. The sensor region 800 illustrates an example exit gate, such as an AC exit location 806, such as shown and described with respect to zone G 118(5) of FIGS. 1-3 and in FIGS. 9-11. Similar to the example of FIG. 7, the sensor region 800 includes devices 808 holding antennas 810 at heights H1 and H2, as described above. The devices 808 define a lane where the user 802 may pass through holding the items 804. As the items 804 pass through the lane, the antenna 810 may read the RFID tags and convey the information to the RFID reader 812 for use by the system in identifying the items 804 associated with the user 802.

FIG. 9 illustrates an AC exit location 900 of the facility with sensors 906 to disambiguate between zones at the AC exit location 900, according to at least one example. Though described with respect to an AC exit location, other sensor locations throughout a facility may be likewise configured and equipped. The AC exit location 900 includes sensors 908(1)-(6) which may be similar to sensors 704 of FIG. 7 and/or device 808 of FIG. 8 and include antennas coupled with an RFID reader to read RFID tag of items. The user 902 passes into region A 910 of the AC exit location where sensors 908(1)-(4) may detect RFID tags of items carried or possessed by user 902. The sensors 908(1)-(4) are directed towards the center of the lane where the user 902 walks such that the entire lane is covered and RFID tags may be easily detected. Furthermore, barriers between the lanes may prevent incidental reading of RFID tags from adjacent lanes. A second user 914 is located in region B 912 which may be covered by sensors 908(5)-(6) to detect items associated with the second user 914. In this manner, users that follow each other may be distinguished based on whether they are located in region A 910 or region B 912 with the corresponding items read by the sensors 908.

In the example of FIG. 9, the sensor 906 may further aid in distinguishing the location of user 902 and user 914 based on their tracked location. Furthermore, the sensor 906 may be used to activating the sensors 908 of the AC exit location 900. In an illustrative example, the sensors 908 may be deactivated in one or all of the lanes of the AC exit location 900 when no users are present in the region. Upon detection, using the sensor 906 of a user approaching or entering the AC exit location 900, the system may activate the sensors 908 either across the entire AC exit location 900 and/or in a particular lane based on the detected location and direction of travel of the user. In this manner, RFID signals may be reduced within the facility to reduce RFID noise and interference, as well as to reduce power consumption by the system. Upon detection of the user exiting the AC exit location 900, the system may deactivate the sensors 908.

While within the AC exit location 900, the system may direct the user 902 and/or the user 914 to proceed through the lanes at varying rates and/or through varying lanes. For example, a light or other device may indicate when a user is clear to proceed through a lane, or may direct a user to a particular lane. In this manner, users may be guided to proceed through at varying rates, which results in different timestamps and locations for detections of users and items, as described herein, that may be used for item association.

FIG. 10 illustrates an AC exit gate of the facility with presence sensors to disambiguate between zones at the exit gate, location 1000 similar to described with respect to the AC exit location 900 of FIG. 9, but includes additional sensors 1006 for detecting a presence of a user within the lanes. In the example of FIG. 10, the AC exit location 1000 includes sensors 1008 similar to the sensors 908 of FIG. 9 but also includes sensors 1006 that may be used to determine when a user enters region A 1010, exits region A 1010, and enters region B 1012. In some examples the sensors 1006 may include beam break sensors, proximity sensors, distance sensors, or other such sensors. The sensors 1006 detect when a user crosses a threshold into the next region and can mark a timestamp for such activity. The timestamp may be used in connection with a timestamp for an RFID tag being detected by the sensors 1008 for item disambiguation between subsequent users, such as from user 1002 carrying item 1004 to user 1014 carrying item 1016.

In some examples, as described above, the sensors 1008 may be activated and/or brought out of a low power mode in response to a signal from sensors 1006 indicating a presence of a user and/or a movement from one region to the next. Additionally, the sensors 1006 may be used to deactivate the sensors 1008 and thereby conserve power and reduce RFID interference within the facility.

FIG. 11 illustrates an AC exit location 1100 of the facility with RFID antennas directed to define zones at the AC exit location 1100 for detecting items, according to at least one example. In the example of FIG. 11, the sensors 1106 are directed towards the centers of the lanes within region A 1108 and region B 1110 to identify items carried by users. The items may be uniquely identified as carried by a first user 1102 or a second user 1112 based on which sensors 1106 detect the items. Items detected by sensors 1106(5)-(6) may be associated with user 1112, such as item 1114, while items detected by the other sensors 1106 may be associated with user 1102, such as item 1104. In some examples, the sensors 1106 may also detect a signal, such as an RFID signal of a card, chip, or mobile device of the user, and thereby determine a user associated with the items without input from additional sensors such as a vision system.

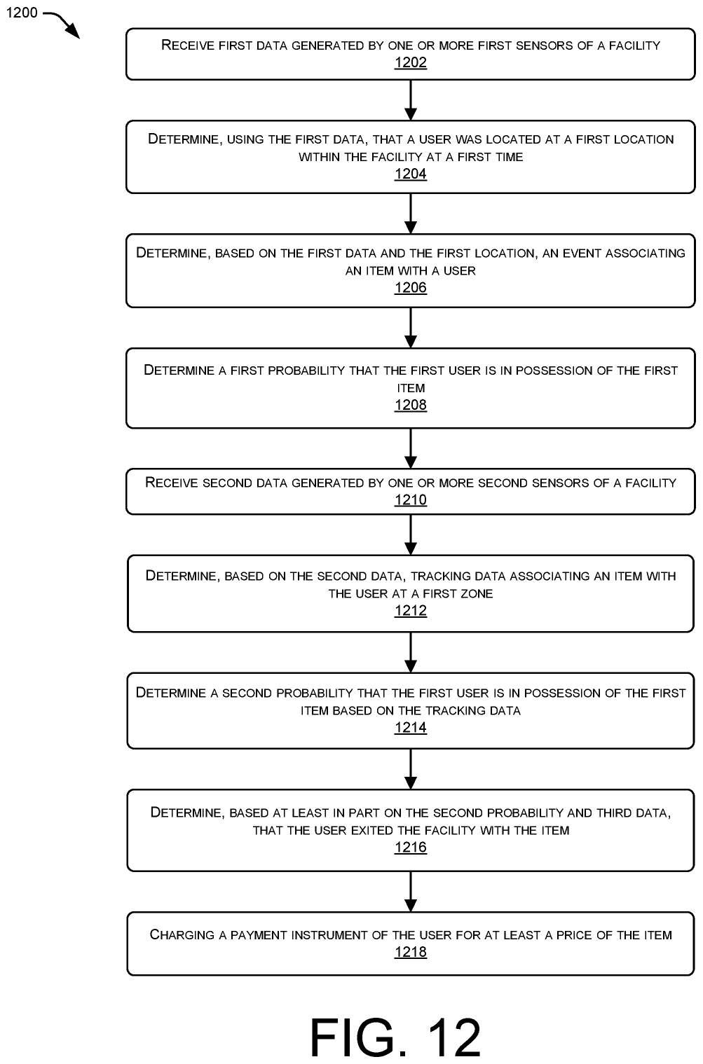

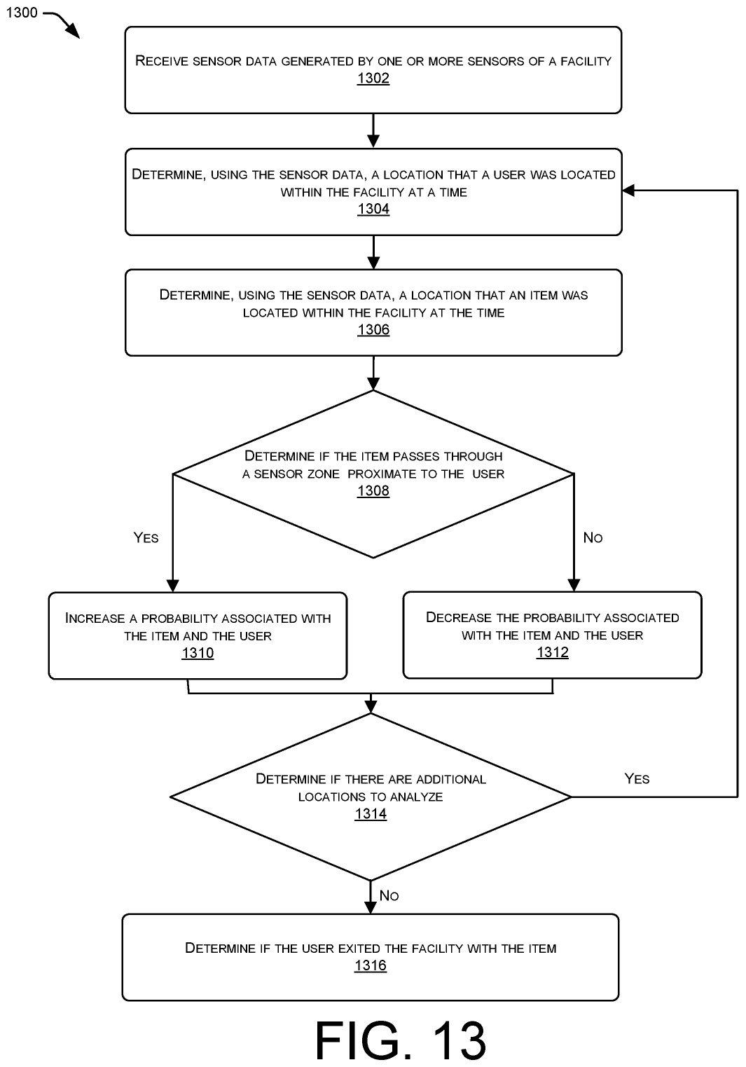

FIGS. 12-13 illustrate various processes for implementing AC techniques for customers of facilities. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed.

FIG. 12. is an example process 1200 for using locations of a user and locations of an item to determine that the user was in possession of the item when exiting a facility. At 1202, the process 1200 may include receiving first data generated by one or more first sensors of a facility. The one or more first sensors may include cameras within the facility and may include sensor data showing a portion of the facility at one or more time periods.

At 1204, the process 1200 may include determining, using the first data, that a user was located at a first location within the facility at a first time. The first user may be identified based on one or more user characteristics, mobile device, trackers, or other methods of tracking within the facility, after receiving consent to track the user within the facility. The first location may include an inventory location where inventory items are stored within the facility.

At 1206, the process 1200 may include determining, based on the first data and the first location, an event associating an item with a user. The event may include an event such as a pickup, a selection, an interaction, or other such event including the user and one or more items at the first location. In some examples, the event may be identified based on one or more sensors associated with an inventory location, such as weight sensors indicating an item was removed from a shelf location.

At 1208, the process 1200 may include determining a first probability that the first user is in possession of the first item. The system of the facility may determine a first probability that the user picked up the item and kept the item in their possession. The first probability may be determined based on the data from the first sensors as well as from other sensors including sensors within a cart associated with the user, sensors of an inventory location, and other such sensors.

At 1210, the process 1200 may include receiving second data generated by one or more second sensors of a facility. The second data may be received from an RFID sensor, such as described herein. The second data may be received by the system in response to the RFID sensor detecting the presence of an RFID tag associated with an item being within a sensing region of the RFID sensor.

At 1212, the process 1200 may include determining, based on the second data, tracking data associating an item with the user at a first zone. The tracking data may include one or more locations where the user was positioned within the facility during particular periods of time. The second data may indicate a sequence of sensors and/or locations where the item was detected by RFID sensors.

At 1214, the process 1200 may include determining a second probability that the first user is in possession of the first item based on the tracking data. The second probability may be determined based on a comparison of the tracking data of the user and the locations where the item was detected by RFID sensors. The tracking data and second sensor data may also be associated with timestamps such that times and locations for the user and the item may be analyzed to determine a probability that the user is carrying or otherwise in possession of the item. The second probability may be determined by increasing or decreasing the first probability based on analysis of the tracking data and the second sensor data.

At 1216, the process 1200 may include determining, based at least in part on the second probability and third data, that the user exited the facility with the item. The third data may include data indicating an exit of the user from the facility and the system may determine that the user exited the facility with the item in response to the second probability exceeding a threshold level. In some examples, the user may be directed to a manual checkout location in response to the second probability being below a threshold value.

At 1218, the process 1200 may include charging a payment instrument for a price of the item. For instance, the system may use an identifier associated with the user to identify an account of the user. Based on the user exiting the facility with the item, the system may store data that associates an identifier of the item with the account. Additionally, the system may charge a payment instrument for the price of the item. In some instances, the system charges the payment instrument using payment information that is stored in association with the account.

FIG. 13 is an example process 1300 for determining whether a user is in possession of an item. At 1302, the process 1300 may include receiving sensor data generated by one or more sensors of a facility. For instance, the system may receive the sensor data generated by the one or more sensors. In some instances, the one or more sensors may include cameras, signal readers, weight sensors, and/or any other type of sensor that is capable of generating the sensor data. The one or more sensors may be located at various locations within the facility. For example, the one or more sensors may be located at the entrance, the exit, the inventory locations, and/or the like of the facility.

At 1304, the process 1300 may include determining, using the sensor data, a location that a user was located within the facility at a time and at 1306, the process 1300 may include determining, using the sensor data, a location that an item was located within the facility at the time. For instance, the system may analyze the sensor data to determine the location of the user and the location of the item at the time. In some instances, the system determines the location of the user and/or the location of the item while the user is still located within the facility. In some instances, the system determines the location of the user and/or the location of the item after the user exits the facility.

At 1308, the process 1300 may include determining if the item passes through a sensor zone proximate to the user. The sensor zone may include an RFID zone where an RFID tag of the item is read. The location of the user may be determined using the sensor data at 1302. For example, the system may determine if the item was located proximate to the user at the time the item was in the sensor zone. In some instances, the system may determine that the item was located proximate to the user when the item was located within a threshold distance to the user at the time.

If, at 1308, it is determined that the item passed through a sensor zone proximate to the user, then at 1310, the process 1300 may include increasing a probability associated with the item and the user. For instance, if the system determines that the item was located proximate to the user, then the system may increase the probability that the user was in possession of the item while within the facility and/or when exiting the facility. In some instances, the system may utilize a weight when increasing the probability. For example, if the location of the user is proximate to the exit of the facility, then the system may provide more weight (e.g., increase the probability by a greater amount) than if the location of the user was not proximate to the exit of the facility.

However, if, at 1308, it is determined that the item did not pass through a sensor zone proximate to the user, then at 1312, the process 1300 may include decreasing the probability associated with the item and the user. For instance, if the system determines that the item was not located proximate to the user, then the system may decrease the probability that the user was in possession of the item while within the facility and/or when exiting the facility. In some instances, the system may utilize a weight when decreasing the probability. For example, if the location of the user is proximate to the exit of the facility, then the system may provide more weight (e.g., decrease the probability by a greater amount) than if the location of the user was not proximate to the exit of the facility.

At 1314, the process 1300 may determine if there are additional locations to analyze. For example, the system may determine whether there is data indicating that the user and/or the item were located at additional sensor zones within the facility. If, at 1314, it is determined that there are additional locations to analyze, then the process 1300 may repeat back at 1304. For instance, if the system determines that there are additional locations to analyze, then the system may perform 1304-1312 to continue to update the probability.

However, if, at 1314, it is determined that there are not additional locations to analyze, then at 1316, the process 1300 may include determining if the user exited the facility with the item. For instance, if the system determines that there are no additional locations to analyze, then the system may determine if the user exited the facility with the item. In some instances, the system may determine that the user did not exit the facility with the item when the probability does not satisfy a threshold probability. Additionally, the system may determine that the user exited the facility with the item when the probability satisfies the threshold probability. The system may then store data that associates an identifier of the item with an account associated with the user and may charge an account or payment device of the user accordingly.

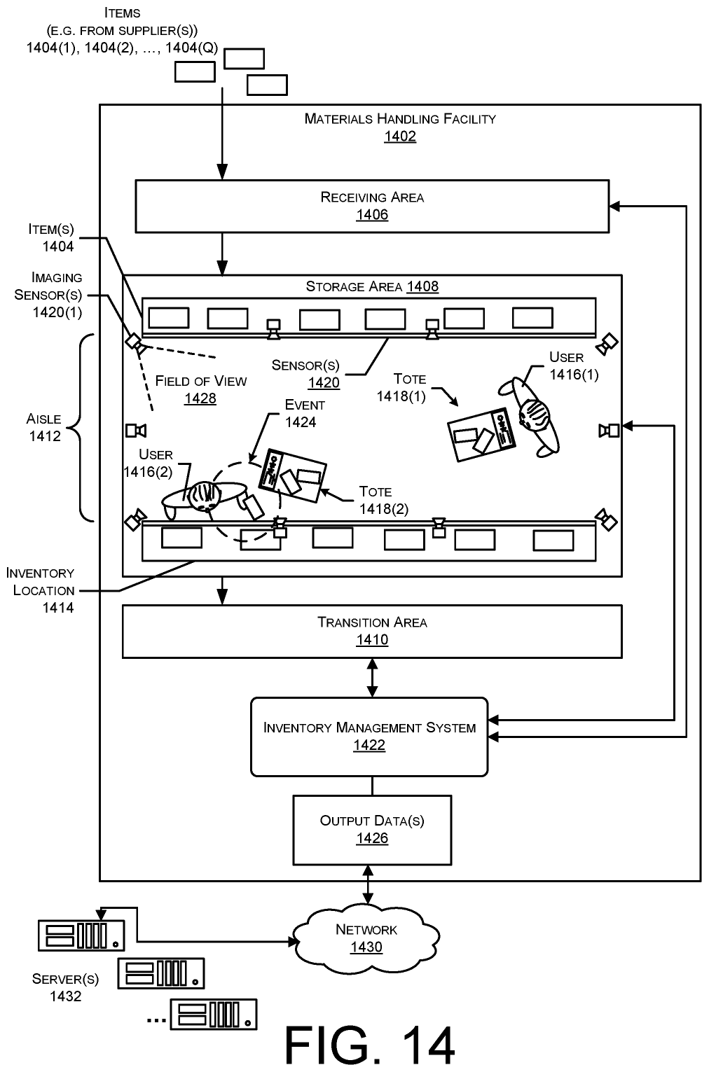

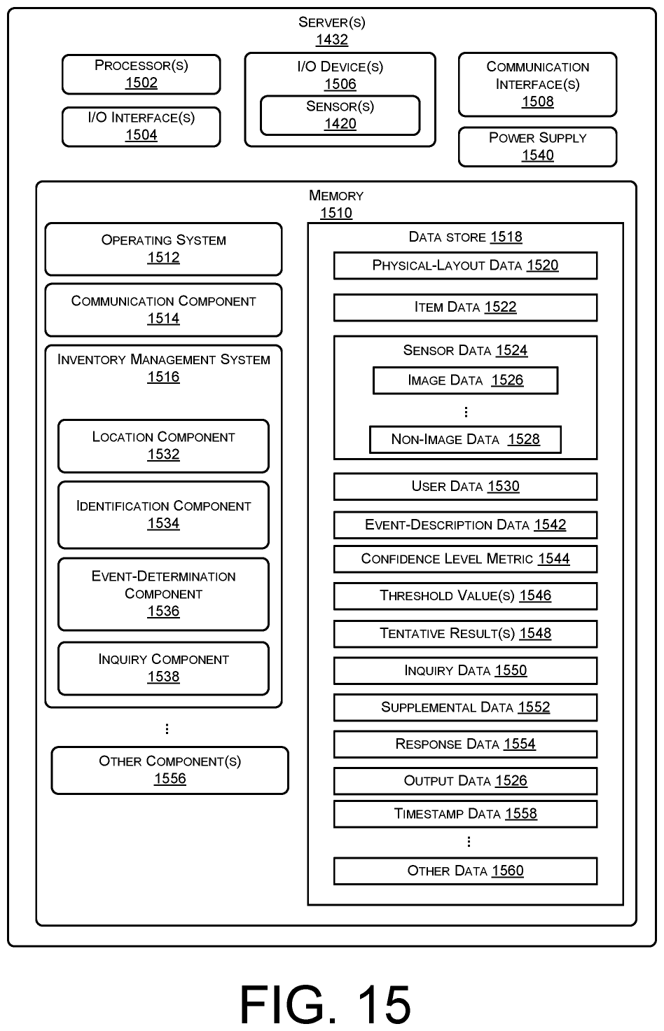

FIGS. 14 and 15 represent an illustrative materials handing environment, such as the materials handling facility 1402, in which the techniques described herein may be applied to cameras monitoring the environments as described below. However, the following description is merely one illustrative example of an industry and environment in which the techniques described herein may be utilized. The materials handling facility 1402 (or “facility”) comprises one or more physical structures or areas within which one or more items 1404(1), 1404(2), . . . , 1404(Q) (also referred to as “items 1404”) may be held. As used in this disclosure, letters in parentheses such as “(Q)” indicate an integer result. The items 1404 comprise physical goods, such as books, pharmaceuticals, repair parts, electronic gear, groceries, and so forth.

The facility 1402 may include one or more areas designated for different functions with regard to inventory handling. In this illustration, the facility 1402 includes a receiving area 1406, a storage area 1408, and a transition area 1410. The receiving area 1406 may be configured to accept items 1404, such as from suppliers, for intake into the facility 1402. For example, the receiving area 1406 may include a loading dock at which trucks or other freight conveyances unload the items 1404.

The storage area 1408 is configured to store the items 1404. The storage area 1408 may be arranged in various physical configurations. In one implementation, the storage area 1408 may include one or more aisles 1412. The aisle 1412 may be configured with, or defined by, inventory locations 1414 on one or both sides of the aisle 1412. The inventory locations 1414 may include one or more of shelves, racks, cases, cabinets, bins, floor locations, or other suitable storage mechanisms for holding or storing the items 1404. The inventory locations 1414 may be affixed to the floor or another portion of the facility's structure, or may be movable such that the arrangements of aisles 1412 may be reconfigurable. In some implementations, the inventory locations 1414 may be configured to move independently of an outside operator. For example, the inventory locations 1414 may comprise a rack with a power source and a motor, operable by a computing device to allow the rack to move from one location within the facility 1402 to another.

One or more users 1416(1), 1416(2) (also referred to as “users 1416”)), totes 1418(1), 1418(2) (also referred to as “totes 1418”)) or other material handling apparatus may move within the facility 1402. For example, the users 1416 may move about within the facility 1402 to pick or place the items 1404 in various inventory locations 1414, placing them on the totes 1418 for ease of transport. A tote 1418 is configured to carry or otherwise transport one or more items 1404. For example, a tote 1418 may include a basket, a cart, a bag, and so forth. In other implementations, other agencies such as robots, forklifts, cranes, aerial drones, and so forth, may move about the facility 1402 picking, placing, or otherwise moving the items 1404.

One or more sensors 1420 may be configured to acquire information in the facility 1402. The sensors 1420 in the facility 1402 may include sensors fixed in the environment (e.g., ceiling-mounted cameras) or otherwise, such as sensors in the possession of users (e.g., mobile phones, tablets, etc.). The sensors 1420 may include, but are not limited to, cameras 1420(1), weight sensors, radio frequency (RF) receivers, temperature sensors, humidity sensors, vibration sensors, and so forth. The sensors 1420 may be stationary or mobile, relative to the facility 1402. For example, the inventory locations 1414 may contain cameras 1420(1) configured to acquire images of pick or placement of items 1404 on shelves, of the users 1416(1) and 1416(2) in the facility 1402, and so forth. In another example, the floor of the facility 1402 may include weight sensors configured to determine a weight of the users 1416 or another object thereupon.

During operation of the facility 1402, the sensors 1420 may be configured to provide information suitable for tracking how objects move or other occurrences within the facility 1402. For example, a series of images acquired by a camera 1420(1) may indicate removal of an item 1404 from a particular inventory location 1414 by one of the users 1416 and placement of the item 1404 on or at least partially within one of the totes 1418.

While the storage area 1408 is depicted as having one or more aisles 1412, inventory locations 1414 storing the items 1404, sensors 1420, and so forth, it is understood that the receiving area 1406, the transition area 1410, or other areas of the facility 1402 may be similarly equipped. Furthermore, the arrangement of the various areas within the facility 1402 is depicted functionally rather than schematically. For example, multiple different receiving areas 1406, storage areas 1408, and transition areas 1410 may be interspersed rather than segregated in the facility 1402.

The facility 1402 may include, or be coupled to, an inventory management system 1422, which may perform some or all of the techniques described above with reference to FIGS. 1-13. For example, the inventory management system 1422 may maintain a virtual cart of each user within the facility. The inventory management system 1422 may also store a record associated with each user indicating an identifier associated with the user, the location of the user, and whether the user is eligible to exit the facility with one or more items without performing a manual checkout of the items. The inventory management system 1422 may also generate and output notification data to the users 1416, indicating whether or not they are so eligible.

As illustrated, the inventory management system 1422 may reside at the facility 1402 (e.g., as part of on-premises servers), on the servers 1432 that are remote from the facility 1402, a combination thereof. In each instance, the inventory management system 1422 is configured to identify interactions and events with and between users 1416, devices such as sensors 1420, robots, material handling equipment, computing devices, and so forth, in one or more of the receiving area 1406, the storage area 1408, or the transition area 1410. As described above, some interactions may further indicate the existence of one or more events 1424, or predefined activities of interest. For example, events 1424 may include the entry of the user 1416 to the facility 1402, stocking of items 1404 at an inventory location 1414, picking of an item 1404 from an inventory location 1414, returning of an item 1404 to an inventory location 1414, placement of an item 1404 within a tote 1418, movement of users 1416 relative to one another, gestures by the users 1416, and so forth. Other events 1424 involving users 1416 may include the user 1416 providing authentication information in the facility 1402, using a computing device at the facility 1402 to authenticate identity to the inventory management system 1422, and so forth. Some events 1424 may involve one or more other objects within the facility 1402. For example, the event 1424 may comprise movement within the facility 1402 of an inventory location 1414, such as a counter mounted on wheels. Events 1424 may involve one or more of the sensors 1420. For example, a change in operation of a sensor 1420, such as a sensor failure, change in alignment, and so forth, may be designated as an event 1424. Continuing the example, movement of a camera 1420(1) resulting in a change in the orientation of the field of view 1428 (such as resulting from someone or something bumping the camera 1420(1)) may be designated as an event 1424.

By determining the occurrence of one or more of the events 1424, the inventory management system 1422 may generate output data 1426. The output data 1426 comprises information about the event 1424. For example, where the event 1424 comprises an item 1404 being removed from an inventory location 1414, the output data 1426 may comprise an item identifier indicative of the particular item 1404 that was removed from the inventory location 1414 and a user identifier of a user that removed the item.

The inventory management system 1422 may use one or more automated systems to generate the output data 1426. For example, an artificial neural network, one or more classifiers, or other automated machine learning techniques may be used to process the sensor data from the one or more sensors 1420 to generate output data 1426. For example, the inventory management system 1422 may perform some or all of the techniques for generating and utilizing a classifier for identifying user activity in image data, as described in detail above. The automated systems may operate using probabilistic or non-probabilistic techniques. For example, the automated systems may use a Bayesian network. In another example, the automated systems may use support vector machines to generate the output data 1426 or the tentative results. The automated systems may generate confidence level data that provides information indicative of the accuracy or confidence that the output data 1426 or the tentative data corresponds to the physical world.

The confidence level data may be generated using a variety of techniques, based at least in part on the type of automated system in use. For example, a probabilistic system using a Bayesian network may use a probability assigned to the output as the confidence level. Continuing the example, the Bayesian network may indicate that the probability that the item depicted in the image data corresponds to an item previously stored in memory is 80%. This probability may be used as the confidence level for that item as depicted in the image data.

In another example, output from non-probabilistic techniques such as support vector machines may have confidence levels based on a distance in a mathematical space within which the image data of the item and the images of previously stored items have been classified. The greater the distance in this space from a reference point such as the previously stored image to the image data acquired during the occurrence, the lower the confidence level.

In yet another example, the image data of an object such as an item 1404, user 1416, and so forth, may be compared with a set of previously stored images. Differences between the image data and the previously stored images may be assessed. For example, differences in shape, color, relative proportions between features in the images, and so forth. The differences may be expressed in terms of distance with a mathematical space. For example, the color of the object as depicted in the image data and the color of the object as depicted in the previously stored images may be represented as coordinates within a color space.

The confidence level may be determined based at least in part on these differences. For example, the user 1416 may pick an item 1404(1) such as a perfume bottle that is generally cubical in shape from the inventory location 1414. Other items 1404 at nearby inventory locations 1414 may be predominantly spherical. Based on the difference in shape (cube vs. sphere) from the adjacent items, and the correspondence in shape with the previously stored image of the perfume bottle item 1404(1) (cubical and cubical), the confidence level that the user 1416 has picked up the perfume bottle item 1404(1) is high.

In some situations, the automated techniques may be unable to generate output data 1426 with a confidence level above a threshold result. For example, the automated techniques may be unable to distinguish which user 1416 in a crowd of users 1416 has picked up the item 1404 from the inventory location 1414. In other situations, it may be desirable to provide human confirmation of the event 1424 or of the accuracy of the output data 1426. For example, some items 1404 may be deemed age restricted such that they are to be handled only by users 1416 above a minimum age threshold.

In instances where human confirmation is desired, sensor data associated with an event 1424 may be processed to generate inquiry data. The inquiry data may include a subset of the sensor data associated with the event 1424. The inquiry data may also include one or more of one or more tentative results as determined by the automated techniques, or supplemental data. The subset of the sensor data may be determined using information about the one or more sensors 1420. For example, camera data such as the location of the camera 1420(1) within the facility 1402, the orientation of the camera 1420(1), and a field of view 1428 of the camera 1420(1) may be used to determine if a particular location within the facility 1402 is within the field of view 1428. The subset of the sensor data may include images that may show the inventory location 1414 or that the item 1404 was stowed. The subset of the sensor data may also omit images from other cameras 1420(1) that did not have that inventory location 1414 in the field of view 1428. The field of view 1428 may comprise a portion of the scene in the facility 1402 that the sensor 1420 is able to generate sensor data about.

Continuing the example, the subset of the sensor data may comprise a video clip acquired by one or more cameras 1420(1) having a field of view 1428 that includes the item 1404. The tentative results may comprise the “best guess” as to which items 1404 may have been involved in the event 1424. For example, the tentative results may comprise results determined by the automated system that have a confidence level above a minimum threshold.

The facility 1402 may be configured to receive different kinds of items 1404 from various suppliers and to store them until a customer orders or retrieves one or more of the items 1404. A general flow of items 1404 through the facility 1402 is indicated by the arrows of FIG. 14. Specifically, as illustrated in this example, items 1404 may be received from one or more suppliers, such as manufacturers, distributors, wholesalers, and so forth, at the receiving area 1406. In various implementations, the items 1404 may include merchandise, commodities, perishables, or any suitable type of item 1404, depending on the nature of the enterprise that operates the facility 1402. The receiving of the items 1404 may comprise one or more events 1424 for which the inventory management system 1422 may generate output data 1426.

Upon being received from a supplier at receiving area 1406, the items 1404 may be prepared for storage. For example, items 1404 may be unpacked or otherwise rearranged. The inventory management system 1422 may include one or more software applications executing on a computer system to provide inventory management functions based on the events 1424 associated with the unpacking or rearrangement. These inventory management functions may include maintaining information indicative of the type, quantity, condition, cost, location, weight, or any other suitable parameters with respect to the items 1404. The items 1404 may be stocked, managed, or dispensed in terms of countable, individual units or multiples, such as packages, cartons, crates, pallets, or other suitable aggregations. Alternatively, some items 1404, such as bulk products, commodities, and so forth, may be stored in continuous or arbitrarily divisible amounts that may not be inherently organized into countable units. Such items 1404 may be managed in terms of measurable quantity such as units of length, area, volume, weight, time, duration, or other dimensional properties characterized by units of measurement. Generally speaking, a quantity of an item 1404 may refer to either a countable number of individual or aggregate units of an item 1404 or a measurable amount of an item 1404, as appropriate.

After arriving through the receiving area 1406, items 1404 may be stored within the storage area 1408. In some implementations, like items 1404 may be stored or displayed together in the inventory locations 1414 such as in bins, on shelves, hanging from pegboards, and so forth. In this implementation, all items 1404 of a given kind are stored in one inventory location 1414. In other implementations, like items 1404 may be stored in different inventory locations 1414. For example, to optimize retrieval of certain items 1404 having frequent turnover within a large physical facility 1402, those items 1404 may be stored in several different inventory locations 1414 to reduce congestion that might occur at a single inventory location 1414. Storage of the items 1404 and their respective inventory locations 1414 may comprise one or more events 1424. In some instances, device(s) may be placed on one or more of the items 1404, where the devise(s) are used to track the one or more items 1404 while within the facility 1402, as described herein.

When a customer order specifying one or more items 1404 is received, or as a user 1416 progresses through the facility 1402, the corresponding items 1404 may be selected or “picked” from the inventory locations 1414 containing those items 1404. In various implementations, item picking may range from manual to completely automated picking. For example, in one implementation, a user 1416 may have a list of items 1404 they desire and may progress through the facility 1402 picking items 1404 from inventory locations 1414 within the storage area 1408, and placing those items 1404 into a tote 1418. In other implementations, employees of the facility 1402 may pick items 1404 using written or electronic pick lists derived from customer orders. These picked items 1404 may be placed into the tote 1418 as the employee progresses through the facility 1402. Picking may comprise one or more events 1424, such as the user 1416 in moving to the inventory location 1414, retrieval of the item 1404 from the inventory location 1414, and so forth.

After items 1404 have been picked, they may be processed at a transition area 1410. The transition area 1410 may be any designated area within the facility 1402 where items 1404 are transitioned from one location to another or from one entity to another. For example, the transition area 1410 may be a packing station within the facility 1402. When the item 1404 arrives at the transition area 1410, the items 1404 may be transitioned from the storage area 1408 to the packing station. The transitioning may comprise one or more events 1424. Information about the transition may be maintained by the inventory management system 1422 using the output data 1426 associated with those events 1424.

In another example, if the items 1404 are departing the facility 1402 a list of the items 1404 may be obtained and used by the inventory management system 1422 to transition responsibility for, or custody of, the items 1404 from the facility 1402 to another entity. For example, a carrier may accept the items 1404 for transport with that carrier accepting responsibility for the items 1404 indicated in the list. In another example, a customer may purchase or rent the items 1404 and remove the items 1404 from the facility 1402. The purchase or rental may comprise one or more events 1424.

The inventory management system 1422 may access or generate sensor data about the facility 1402 and the contents therein including the items 1404, the users 1416, the totes 1418, and so forth. The sensor data may be acquired by one or more of the sensors 1420, data provided by other systems, and so forth. For example, the sensors 1420 may include cameras 1420(1) configured to acquire image data of scenes in the facility 1402. The image data may comprise still images, video, or a combination thereof. The image data may be processed by the inventory management system 1422 to determine a location of the user 1416, the tote 1418, the identifier associated with the user 1416, and so forth. As used herein, the identifier associated with the user may represent a unique identifier of the user (e.g., number associated with user, username, etc.), an identifier that distinguishes the user amongst other users being located within the environment, or the like.

The inventory management system 1422, or systems coupled thereto, may be configured to determine the identifier associated with the user 1416, as well as to determine other candidate users. In one implementation, this determination may comprise comparing sensor data with previously stored identity data. For example, the identifier associated with the user 1416 may be identified by presenting a token carrying authentication credentials, providing a fingerprint, scanning a barcode or other type of unique identifier upon entering the facility, and so forth. The identifier associated with the user 1416 may be determined before, during, or after entry to the facility 1402. Determination of the user's identifier may comprise comparing sensor data associated with the user 1416 in the facility 1402 to previously stored user data.

In some instances, the inventory management system 1422 groups users within the facility into respective sessions. That is, the inventory management system 1422 may utilize the sensor data to determine groups of users that are effectively “together” (e.g., shopping together). In some instances, a particular session may include multiple users that entered the facility 1402 together and, potentially, that navigate the facility together. For example, when a family of two adults and two children enter the facility together, the inventory management system may associate each user with a particular session. Locating groups in addition to individual users may help in determining the outcome of individual events, given that users within a session may not only individually order, pick, return, or otherwise interact with items, but may also pass the items back and forth amongst each other. For instance, a child in the above example may pick the box of cereal before handing the box to her mother, who may place it in her tote 1418. Noting the child and the mother as belonging to the same session may increase the chances of successfully adding the box of cereal to the virtual shopping cart of the mother.

By determining the occurrence of one or more events 1424 and the output data 1426 associated therewith, the inventory management system 1422 is able to provide one or more services to the users 1416 of the facility 1402. By utilizing one or more human associates to process inquiry data and generate response data that may then be used to produce output data 1426, overall accuracy of the system may be enhanced. The enhanced accuracy may improve the user experience of the one or more users 1416 of the facility 1402. In some examples, the output data 1426 may be transmitted over a network 1430 to one or more servers 1432.

FIG. 11 illustrates a block diagram of the one or more servers 1432. The servers 1432 may be physically present at the facility 1402, may be accessible by the network 1430, or a combination of both. The servers 1432 do not require end-user knowledge of the physical location and configuration of the system that delivers the services. Common expressions associated with the servers 1432 may include “on-demand computing,” “software as a service (SaaS),” “cloud services,” “data centers,” and so forth. Services provided by the servers 1432 may be distributed across one or more physical or virtual devices.

The servers 1432 may include one or more hardware processors 1502 (processors) configured to execute one or more stored instructions. The processors 1502 may comprise one or more cores. The servers 1432 may include one or more input/output (I/O) interface(s) 1504 to allow the processor 1502 or other portions of the servers 1432 to communicate with other devices. The I/O interfaces 1504 may comprise Inter-Integrated Circuit (I2C), Serial Peripheral Interface bus (SPI), Universal Serial Bus (USB) as promulgated by the USB Implementers Forum, and so forth. FIG. 11 also illustrates I/O devices 1506.

The servers 1432 may also include one or more communication interfaces 1508. The communication interfaces 1508 are configured to provide communications between the servers 1432 and other devices, such as the sensors 1420, the interface devices, routers, and so forth. The communication interfaces 1508 may include devices configured to couple to personal area networks (PANs), wired and wireless local area networks (LANs), wired and wireless wide area networks (WANs), and so forth. For example, the communication interfaces 1508 may include devices compatible with Ethernet, Wi-Fi™ and so forth. The servers 1432 may also include one or more busses or other internal communications hardware or software that allow for the transfer of data between the various modules and components of the servers 1432.

The servers 1432 may also include a power supply 1540. The power supply 1540 is configured to provide electrical power suitable for operating the components in the servers 1432.

The servers 1432 may further include one or more memories 1510. The memory 1510 comprises one or more computer-readable storage media (CRSM). The CRSM may be any one or more of an electronic storage medium, a magnetic storage medium, an optical storage medium, a quantum storage medium, a mechanical computer storage medium, and so forth. The memory 1510 provides storage of computer-readable instructions, data structures, program modules, and other data for the operation of the servers 1432. A few example functional modules are shown stored in the memory 1510, although the same functionality may alternatively be implemented in hardware, firmware, or as a system on a chip (SOC).

The memory 1510 may include at least one operating system (OS) component 1512. The OS component 1512 is configured to manage hardware resource devices such as the I/O interfaces 1504, the communication interfaces 1508, and provide various services to applications or components executing on the processors 1502. The OS component 1512 may implement a variant of the FreeBSD™ operating system as promulgated by the FreeBSD Project; other UNIX™ or UNIX-like variants; a variation of the Linux™ operating system as promulgated by Linus Torvalds; the Windows® Server operating system from Microsoft Corporation of Redmond, Washington, USA; and so forth.

One or more of the following components may also be stored in the memory 1510. These components may be executed as foreground applications, background tasks, daemons, and so forth. A communication component 1514 may be configured to establish communications with one or more of the sensors 1420, one or more of the devices used by associates, other servers 1432, or other devices. The communications may be authenticated, encrypted, and so forth.

The memory 1510 may store an inventory management system 1516. The inventory management system 1516 is configured to provide the inventory functions as described herein with regard to the inventory management system 1422. For example, the inventory management system 1516 may track movement of items 1404 in the facility 1402, generate user interface data, and so forth.

The inventory management system 1516 may access information stored in one or more data stores 1518 in the memory 1510. The data store 1518 may use a flat file, database, linked list, tree, executable code, script, or other data structure to store the information. In some implementations, the data store 1518 or a portion of the data store 1518 may be distributed across one or more other devices including other servers 1432, network attached storage devices, and so forth.

The data store 1518 may include physical layout data 1520. The physical layout data 1520 provides a mapping of physical locations within the physical layout of devices and objects such as the sensors 1420, inventory locations 1414, and so forth. The physical layout data 1520 may indicate the coordinates within the facility 1402 of an inventory location 1414, sensors 1420 within view of that inventory location 1414, and so forth. For example, the physical layout data 1520 may include camera data comprising one or more of a location within the facility 1402 of a camera 1420(1), orientation of the camera 1420(1), the operational status, and so forth. Continuing example, the physical layout data 1520 may indicate the coordinates of the camera 1420(1), pan and tilt information indicative of a direction that the field of view 1428 is oriented along, whether the camera 1420(1) is operating or malfunctioning, and so forth.

In some implementations, the inventory management system 1516 may access the physical layout data 1520 to determine if a location associated with the event 1424 is within the field of view 1428 of one or more sensors 1420. Continuing the example above, given the location within the facility 1402 of the event 1424 and the camera data, the inventory management system 1516 may determine the cameras 1420(1) that may have generated images of the event 1424.

The item data 1522 comprises information associated with the items 1404. The information may include information indicative of one or more inventory locations 1414 at which one or more of the items 1404 are stored. The item data 1522 may also include event data, SKU or other product identifier, price, quantity on hand, weight, expiration date, images of the item 1404, detail description information, ratings, ranking, and so forth. Still, in some instances, the item data 1522 may include device data that associated items with devices that are used to track the locations of the items within the facility 1402. The inventory management system 1516 may store information associated with inventory management functions in the item data 1522.

The data store 1518 may also include sensor data 1524. The sensor data 1524 comprises information acquired from, or based on, the one or more sensors 1420. For example, the sensor data 1524 may comprise 3D information about an object in the facility 1402. As described above, the sensors 1420 may include a camera 1420(1), which is configured to acquire one or more images. These images may be stored as the image data 1526. The image data 1526 may comprise information descriptive of a plurality of picture elements or pixels. Non-image data 1528 may comprise information from other sensors 1420, such as input from microphones, weight sensors, and so forth.

User data 1530 may also be stored in the data store 1518. The user data 1530 may include identity data, information indicative of a profile, purchase history, location data, demographic data, and so forth. Individual users 1416 or groups of users 1416 may selectively provide user data 1530 for use by the inventory management system 1422. The individual users 1416 or groups of users 1416 may also authorize collection of the user data 1530 during use of the facility 1402 or access to user data 1530 obtained from other systems. For example, the user 1416 may opt-in to collection of the user data 1530 to receive enhanced services while using the facility 1402.

In some implementations, the user data 1530 may include information designating a user 1416 for special handling. For example, the user data 1530 may indicate that a particular user 1416 has been associated with an increased number of errors with respect to output data 1426. The inventory management system 1516 may be configured to use this information to apply additional scrutiny to the events 1424 associated with this user 1416. For example, events 1424 that include an item 1404 having a price or result above the threshold amount may be provided to the associates for processing regardless of the determined level of confidence in the output data 1426 as generated by the automated system.

The inventory management system 1516 may include one or more of a location component 1532, identification component 1534, event-determination component 1536, and inquiry component 1538, potentially amongst other components 1556.

The location component 1532 functions to locate items or users within the environment of the facility to allow the inventory management system 1516 to assign certain events to the correct users. That is, the location component 1532 may assign unique identifiers to users as they enter the facility and, with the users' consent, may locate the users throughout the facility 1402 over the time they remain in the facility 1402. The location component 1532 may perform this locating using sensor data 1524, such as the image data 1526. For example, the location component 1532 may receive the image data 1526 and analyze the image data 1526 to identify users from the images. After identifying a particular user within the facility, the location component 1532 may then locate the user within the images as the user moves throughout the facility 1402. Further, should the location component 1532 temporarily “lose” a particular user, the location component 1532 may again attempt to identify the users within the facility based on facial recognition, and/or using other techniques such as voice recognition, or the like.

Therefore, upon receiving the indication of the time and location of the event in question, the location component 1532 may query the data store 1518 to determine which one or more users were at or within a threshold distance of the location of the event at the particular time of the event. Further, the location component 1532 may assign different confidence levels to different users, with the confidence levels indicating how likely it is that each corresponding user is the user that is in fact associated with the event of interest.

The location component 1532 may access the sensor data 1524 in order to determine this location data of the user and/or items. The location data provides information indicative of a location of an object, such as the item 1404, the user 1416, the tote 1418, and so forth. The location may be absolute with respect to the facility 1402 or relative to another object or point of reference. Absolute terms may comprise a latitude, longitude, and altitude with respect to a geodetic reference point. Relative terms may include a location of 210.4 meters (m) along an x-axis and 710.2 m along a y-axis as designated by a floor plan of the facility 1402, 10.2 m from an inventory location 1414 along a heading of 110°, and so forth. For example, the location data may indicate that the user 1416(1) is 210.2 m along the aisle 1412(1) and standing in front of the inventory location 1414. In comparison, a relative location may indicate that the user 1416(1) is 32 cm from the tote 1418 at a heading of 73° with respect to the tote 1418. The location data may include orientation information, such as which direction the user 1416 is facing. The orientation may be determined by the relative direction the user's body is facing. In some implementations, the orientation may be relative to the interface device. Continuing the example, the location data may indicate that the user 1416(1) is oriented with a heading of 0°, or looking north. In another example, the location data may indicate that the user 1416 is facing towards the interface device.

The identification component 1534 is configured to identify an object. In one implementation, the identification component 1534 may be configured to identify an item 1404. In another implementation, the identification component 1534 may be configured to identify an identifier associated with the user 1416. For example, the identification component 1534 may process the image data 1526 and determine the identity data of the user 1416 depicted in the images by comparing the characteristics in the image data 1526 with previously stored results. The identification component 1534 may also access data from other sensors 1420, such as from an RFID reader, an RF receiver, fingerprint sensors, and so forth.

The event-determination component 1536 is configured to process the sensor data 1524 and generate output data 1426, and may include components described above. The event-determination component 1536 may access information stored in the data store 1518 including, but not limited to, event-description data 1542, confidence levels 1544, or threshold values 1146. In some instances, the event-determination component 1536 may be configured to perform some or all of the techniques described above with regards to the event-determination component 1536. For instance, the event-determination component 1536 may be configured to create and utilize event classifiers for identifying events (e.g., predefined activity) within image data, potentially without use of other sensor data acquired by other sensors in the environment.

The event-description data 1542 comprises information indicative of one or more events 1424. For example, the event-description data 1542 may comprise predefined profiles that designate movement of an item 1404 from an inventory location 1414 with the event 1424 of “pick”. The event-description data 1542 may be manually generated or automatically generated. The event-description data 1542 may include data indicative of triggers associated with events occurring in the facility 1402. An event may be determined as occurring upon detection of the trigger. For example, sensor data 1524 such as a change in weight from a sensor 1420 at an inventory location 1414 may trigger detection of an event of an item 1404 being added or removed from the inventory location 1414. In another example, the trigger may comprise an image of the user 1416 reaching a hand toward the inventory location 1414. In yet another example, the trigger may comprise two or more users 1416 approaching to within a threshold distance of one another.

The event-determination component 1536 may process the sensor data 1524 using one or more techniques including, but not limited to, artificial neural networks, classifiers, decision trees, support vector machines, Bayesian networks, and so forth. For example, the event-determination component 1536 may use a decision tree to determine occurrence of the “pick” event 1424 based on sensor data 1524. The event-determination component 1536 may further use the sensor data 1524 to determine one or more tentative results 1548. The one or more tentative results 1548 comprise data associated with the event 1424. For example, where the event 1424 comprises a disambiguation of users 1416, the tentative results 1548 may comprise a list of possible user identities. In another example, where the event 1424 comprises a disambiguation between items, the tentative results 1548 may comprise a list of possible item identifiers. In some implementations, the tentative result 1548 may indicate the possible action. For example, the action may comprise the user 1416 picking, placing, moving an item 1404, damaging an item 1404, providing gestural input, and so forth.

In some implementations, the tentative results 1548 may be generated by other components. For example, the tentative results 1548 such as one or more possible identities or locations of the user 1416 involved in the event 1424 may be generated by the location component 1532. In another example, the tentative results 1548 such as possible items 1404 that may have been involved in the event 1424 may be generated by the identification component 1534.

The event-determination component 1536 may be configured to provide a confidence level 1544 associated with the determination of the tentative results 1548. The confidence level 1544 provides indicia as to the expected level of accuracy of the tentative result 1548. For example, a low confidence level may indicate that the tentative result 1548 has a low probability of corresponding to the actual circumstances of the event 1424. In comparison, a high confidence level may indicate that the tentative result 1548 has a high probability of corresponding to the actual circumstances of the event 1424.

In some implementations, the tentative results 1548 having confidence levels 1544 that exceed the threshold may be deemed to be sufficiently accurate and thus may be used as the output data 1426. For example, the event-determination component 1536 may provide tentative results 1548 indicative of the three possible items 1404(1), 1404(2), and 1404(3) corresponding to the “pick” event 1424. The confidence levels 1544 associated with the possible items 1404(1), 1404(2), and 1404(3) may be 210%, 70%, 102%, respectively. Continuing the example, the threshold value 1146 may be set such that confidence level 1544 of 100% are deemed to be sufficiently accurate. As a result, the event-determination component 1536 may designate the “pick” event 1424 as involving item 1404(3).

The inquiry component 1538 may be configured to use at least a portion of the sensor data 1524 associated with the event 1424 to generate inquiry data 1550. In some implementations, the inquiry data 1550 may include one or more of the tentative results 1548 or supplemental data 1552. The inquiry component 1538 may be configured to provide inquiry data 1550 to one or more devices associated with one or more human associates.

An associate user interface is presented on the respective devices of associates. The associate may generate response data 1554 by selecting a tentative result 1548, entering new information, indicating that they are unable to answer the inquiry, and so forth.

The supplemental data 1552 comprises information associated with the event 1424 or that may be useful in interpreting the sensor data 1524. For example, the supplemental data 1552 may comprise previously stored images of the items 1404. In another example, the supplemental data 1552 may comprise one or more graphical overlays. For example, the graphical overlays may comprise graphical user interface elements such as overlays depicting indicia of an object of interest. These indicia may comprise highlights, bounding boxes, arrows, and so forth, that have been superimposed or placed atop the image data 1526 during presentation to an associate.

The inquiry component 1538 processes the response data 1554 provided by the one or more associates. The processing may include calculating one or more statistical results associated with the response data 1554. For example, statistical results may include a count of the number of times associates selected a tentative result 1548, determination of a percentage of the associates that selected a tentative result 1548, and so forth.

The inquiry component 1538 is configured to generate the output data 1426 based at least in part on the response data 1554. For example, given that a majority of the associates returned response data 1554 indicating that the item 1404 associated with the “pick” event 1424 is item 1404(10), the output data 1426 may indicate that the item 1404(10) was picked.

The inquiry component 1538 may be configured to selectively distribute inquiries to particular associates. For example, some associates may be better suited to answering particular types of inquiries. Performance data, such as statistical data about the performance of the associates, may be determined by the inquiry component 1538 from the response data 1554 provided by the associates. For example, information indicative of a percentage of different inquiries in which the particular associate selected response data 1554 that disagreed with the majority of associates may be maintained. In some implementations, test or practice inquiry data having a previously known correct answer may be provided to the associate for training or quality assurance purposes. The determination of the set of associates to use may be based at least in part on the performance data.

By using the inquiry component 1538, the event-determination component 1536 may be able to provide high reliability output data 1426 that accurately represents the event 1424. The output data 1426 generated by the inquiry component 1538 from the response data 1554 may also be used to further train the automated systems used by the inventory management system 1516. For example, the sensor data 1524 and the output data 1426, based on response data 1554, may be provided to one or more of the components of the inventory management system 1516 for training in process improvement. Continuing the example, this information may be provided to an artificial neural network, Bayesian network, and so forth, to further train these systems such that the confidence level 1544 and the tentative results 1548 produced in the future for the same or similar input is improved. Finally, as FIG. 15 illustrates, the servers 1432 may store and/or utilize other data 1560.

In some instances, the servers 1432 may further store the timestamp data 1558, timestamp data 1558 representing locations of users 1416 over time, and other data 1560.

Embodiments may be provided as a software program or computer program product including a non-transitory computer-readable storage medium having stored thereon instructions (in compressed or uncompressed form) that may be used to program a computer (or other electronic device) to perform processes or methods described herein. The computer-readable storage medium may be one or more of an electronic storage medium, a magnetic storage medium, an optical storage medium, a quantum storage medium, and so forth. For example, the computer-readable storage media may include, but is not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. Further, embodiments may also be provided as a computer program product including a transitory machine-readable signal (in compressed or uncompressed form). Examples of machine-readable signals, whether modulated using a carrier or unmodulated, include, but are not limited to, signals that a computer system or machine hosting or running a computer program can be configured to access, including signals transferred by one or more networks. For example, the transitory machine-readable signal may comprise transmission of software by the Internet.

Separate instances of these programs can be executed on or distributed across any number of separate computer systems. Thus, although certain steps have been described as being performed by certain devices, software programs, processes, or entities, this need not be the case, and a variety of alternative implementations will be understood by those having ordinary skill in the art.

Additionally, those having ordinary skill in the art readily recognize that the techniques described above can be utilized in a variety of devices, environments, and situations. Although the subject matter has been described in language specific to structural features or methodological acts, it is to be understood that the subject matter defined in the appended claims is not necessarily limited to the specific features or acts described. Rather, the specific features and acts are disclosed as exemplary forms of implementing the claims.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

1. A system comprising:
one or more cameras located within a facility;
a radio frequency identification (RFID) sensor having a first antenna positioned at a first height and a second antenna positioned at a second height configured to read RFID tags associated with items in the facility, the RFID sensor located at a first location within the facility;
one or more processors; and
one or more computer-readable media storing instructions that, when executed by the one or more processors, cause the one or more processors to perform operations comprising:
receiving first image data generated by the one or more cameras;
analyzing the first image data to determine that a user was located at a second location within the facility at a first time;
analyzing the first image data to determine that a second user was located at the second location within the facility at the first time, the second location outside of a range of one or more sensor systems, the one or more sensor systems separate from the one or more cameras and comprising the RFID sensor;
determining, based on the first image data, an event comprising a selection of an item comprising an RFID tag from an inventory location at the second location, the RFID tag comprising unique item data describing one or more unique characteristics of the item;
determining, based on the first image data, a first probability that the user was in possession of the item;
receiving second image data generated by the one or more cameras;
analyzing the second image data to determine that the user was located at the first location at a second time;
receiving first sensor data generated by the RFID sensor at the second time;
analyzing the first sensor data to determine that the item was located at the first location at the second time;
determining, based at least in part on determining the item was located at the first location at the second time, a second probability that the user was in possession of the item, the second probability being greater than the first probability;
determining, based at least in part on the second probability, that the user exited the facility with the item; and
charging a payment instrument of the user for at least a price of the item.

2. The system of claim 1, wherein the RFID sensor comprises:
an RFID reader;
a first antenna communicably coupled to the RFID reader and positioned at a first height configured to detect a first RFID tag positioned in a basket of a shopping cart within the facility; and
a second antenna communicably coupled to the RFID reader and positioned at a second height configured to detect a second RFID tag positioned in a receptacle carried by a user.

3. The system of claim 1, wherein the operations further comprise:
receiving third image data generated by the one or more cameras;
analyzing the third image data to determine that the user was located at a third location at a third time;
receiving second sensor data generated by a second RFID sensor at a third location at the third time;
analyzing the second sensor data to determine that the item was located at the third location at the third time; and
determining, based at least in part on determining the item was located at the third location at the third time, a third probability that the user was in possession of the item, the third probability being greater than the second probability, and wherein determining that the user exited the facility with the item is further based on the third probability.

4. A method comprising:
determining, based at least in part on first sensor data, that a user was located at a first location within a facility at a first time, the first sensor data determined by a first sensor;
determining, based at least in part on proximity data, that the user entered a sensor zone, the sensor zone comprising a limited region within the facility associated with a second sensor;
activating the second sensor based at least in part on the proximity data;
determining, based at least in part on third sensor data from the second sensor, that an item was located proximate to the second location at the second time, the third sensor data associated with one or more item characteristics of the item;
based at least in part on determining that the item was located proximate to the second location at the second time, associating an identifier associated with the item with an account of the user;
determining, based at least in part on fourth sensor data, that that user exited the facility; and
charging a payment instrument of the user for at least a price of the item.

5. The method as recited in claim 4, further comprising:
determining, based at least in part on the first sensor data, a first probability that the user picked up the item, and
wherein associating the identifier with the account of the user comprises determining, based at least in part on the second sensor data and the third sensor data, a second probability that the user picked up the item, the second probability greater than the first probability.

6. The method as recited in claim 5, further comprising:
determining that the second probability satisfies a threshold probability,
and wherein associating the identifier with the account is based at least in part on the second probability satisfying the threshold probability.

7. The method as recited in claim 5, further comprising:
determining, based at least in part on fifth sensor data, that the user was located at a third location within the facility at a third time, the third time being later than the second time; and
determining, based at least in part on sixth sensor data, that the item was located proximate to the third location at the second time, and
wherein associating the identifier with the account of the user comprises determining, based at least in part on the fifth sensor data and the sixth sensor data, a third probability that the user picked up the item, the third probability greater than the second probability.

8. The method as recited in claim 4, wherein the first sensor comprises one or more image sensors within the facility and the second sensor comprises an RFID sensor.

9. The method as recited in claim 8, further comprising associating unique item information describing the one or more characteristics of the item with an RFID tag connected to the item, and wherein the price of the item is based at least in part on the one or more characteristics.

10. The method as recited in claim 4, wherein the proximity data comprises sensor data from a beam break sensor, and the method further comprises:
activating the second sensor based at least in part on first beam break data associated with a first break in the beam break sensor; and
deactivating the second sensor based at least in part on second beam break data associated with a second break in the beam break sensor

11. The method as recited in claim 4, further comprising:
determining, based at least in part on the first sensor data, that a second user was located at the first location;
determining a first probability that the user has picked up the item based on the first sensor data, the second sensor data, and the third sensor data; and
determining a second probability that the second user has picked up the item based on the first sensor data, the second sensor data, and the third sensor data, and wherein associating the identifier with the account of the user is based on the first probability being greater than the second probability.

12. The method as recited in claim 4, further comprising:
determining, based at least in part on the first sensor data, a first probability that the user picked up the item; and
determining a signal strength associated with the third sensor data, and wherein associating the identifier with the account of the user comprises determining, based at least in part on the second sensor data, the third sensor data, and the signal strength, a second probability that the user picked up the item, the second probability greater than the first probability.

13. The method as recited in claim 4, wherein the first sensor data and second sensor data comprise image data from one or more cameras of a facility used to track locations of the user in the facility, the third sensor data comprises first RFID data from a first RFID sensor within the facility, the method further comprising:
receiving second RFID data from a second RFID sensor within the facility; and
determining a probability that the user picked up the item based on a correlation between the locations of the user in the facility and the first RFID data and the second RFID data, and wherein associating the identifier with the account is further based on the probability.

14. The method as recited in claim 4, further comprising:
determining, based at least in part on the first sensor data, that a second user was located at the first location; and
determining, based at least in part on fourth sensor data, that the second user was located at a third location within the facility at a third time, the third time being later than the first time, and wherein associating the identifier with the account is further based on the fourth sensor data.

15. The method as recited in claim 4, further comprising:
determining, based at least in part on the first sensor data, that a second user was located at the first location; and
determining, based at least in part on fourth sensor data, that the second user was located at the second location within the facility at a third time, the third time being later than the first time, and wherein associating the identifier with the account is further based on the fourth sensor data.

16. A system comprising:
one or more cameras located within a facility;
a radio frequency identification (RFID) sensor located at a sensor location within the facility;
a proximity sensor associated with the sensor location;
one or more processors; and
one or more computer-readable media storing instructions that, when executed by the one or more processors, cause the one or more processors to perform operations comprising:
determining, based at least in part on first sensor data from the one or more cameras, that a user was located at a first location within the facility at a first time;
determining, based at least in part on proximity data from the proximity sensor, that the user entered a sensor zone, the sensor zone comprising a limited region within the facility associated with the RFID sensor;
activating the RFID sensor based at least in part on the proximity data;
determining, based at least in part on third sensor data from the RFID sensor, that an item was located proximate to the sensor location at the second time, the third sensor data associated with one or more item characteristics of the item;
based at least in part on determining that the item was located proximate to the sensor location at the second time, associating an identifier associated with the item with an account of the user;
determining, based at least in part on fourth sensor data, that that user exited the facility; and
charging a payment instrument of the user for at least a price of the item.

17. The system as recited in claim 16, further comprising:
determining, based at least in part on the first sensor data, a first probability that the user picked up the item, and
wherein associating the identifier with the account of the user comprises determining, based at least in part on the second sensor data and the third sensor data, a second probability that the user picked up the item, the second probability greater than the first probability.

18. The system as recited in claim 17, further comprising:
determining, based at least in part on fifth sensor data, that the user was located at a third location within the facility at a third time, the third time being later than the second time; and
determining, based at least in part on sixth sensor data, that the item was located proximate to the third location at the second time, and
wherein associating the identifier with the account of the user comprises determining, based at least in part on the fifth sensor data and the sixth sensor data, a third probability that the user picked up the item, the third probability greater than the second probability.

19. The system as recited in claim 16, wherein the proximity sensor comprises a beam break sensor, and the operations further comprise:
activating the RFID sensor based at least in part on first beam break data associated with a first break in the beam break sensor; and
deactivating the RFID sensor based at least in part on second beam break data associated with a second break in the beam break sensor.

20. The system as recited in claim 16, wherein the first sensor data and second sensor data comprise image data from one or more cameras of a facility used to track locations of the user in the facility, the third sensor data comprises first RFID data from a first RFID sensor within the facility, the operations further comprising:
receiving second RFID data from a second RFID sensor within the facility; and
determining a probability that the user picked up the item based on a correlation between the locations of the user in the facility and the first RFID data and the second RFID data, and wherein associating the identifier with the account is further based on the probability.
